(19) United States
(12) Patent Application Publication
(10) Pub. No.: US 2012/0190002 A1
(43) Pub. Date: Jul. 26, 2012

(54) METHOD SYSTEM AND COMPUTER-READABLE MEDIA FOR WEB BASED TRAINING ON AN INSTRUMENT OR PIECE OF EQUIPMENT

(75) Inventors: Nelson Payne, Mt. Holly, NC (US); William Magagna, Lancaster, PA (US); Shannon M. Bellafiore, West Chester, PA (US); George W. Christopher, Rock Hill, SC (US)

(73) Assignee: Siemens Healthcare Diagnostics Inc., Tarrytown, NY (US)

(21) Appl. No.: 13/388,841

(22) PCT Filed: Aug. 6, 2010
(86) PCT No.: PCT/US10/44699

§ 371 Date: Apr. 11, 2012

Related U.S. Application Data
(60) Provisional application No. 61/231,832, filed on Aug. 6, 2009.
(60) Provisional application No. 61/367,448, filed on Jul. 25, 2010.

(51) Int. Cl. G09B 25/00

(52) U.S. Cl. 434/365

(57) ABSTRACT

Disclosed are methods and systems adapted to provide a single-source, e-training platform for generating an e-training plan and providing e-training courses directed at various competencies in the operation, maintenance, calibration, control testing, and/or troubleshooting of an instrument or piece of equipment. The system includes an e- training module having a content library sub-module of e- training courses, a trainee planner, and a validation sub- module adapted to validate a completion of a practical portion. An administrator module adapted to generate an invite to a trainee, and allow generation of an e-learning plan for a trainee. Computer-readable medium containing an executable version of the methods are provided, as are other aspects.

### RELATED APPLICATIONS

The present application claims priority to U.S. Provisional Patent Application No. 61/231,832, filed Aug. 6, 2009, and entitled “PERSONALIZED EDUCATION PLANNER” (Attorney Docket No. 2009P14193US (SBHD-023-L01)) and claims priority to U.S. Provisional Patent Application No. 61/367,448, filed Jul. 25, 2010, and entitled “METHODS, SYSTEMS, AND COMPUTER-READABLE MEDIA FOR WEB-BASED, TRAINING ON AN INSTRUMENT OR PIECE OF EQUIPMENT” (Attorney Docket No. 2009P14193US (SBHD-023-L02)), both are hereby incorporated herein by reference in their entirety for all purposes.

### FIELD OF THE INVENTION

The present invention relates generally to methods and systems for training individuals on the operation, calibration, and/or troubleshooting of instruments and technical equipment.

### BACKGROUND OF THE INVENTION

In medical testing and processing, automated clinical instruments and equipment may be used to minimize exposure to, or contact with, biological fluid samples (otherwise referred to as “clinical specimens”) and/or may increase productivity of the testing process and/or processing taking place prior to actual testing. Such automated testing instruments and processing equipment, such as clinical chemical analyzers, centrifuges, and the like, although they may be fully or partially automated, may still require an individual (e.g., a highly-trained technician) who is trained in various aspects of the operation (e.g., basic operation, setup, calibration, maintenance, control testing, and the like), as well as maintenance, and troubleshooting of the instrument or piece of equipment.

The training of such individuals generally involves being trained in the operation, calibration, maintenance, and troubleshooting of the instrument by a qualified trainer over a period of days, weeks, or even months. It should be recognized, however, that such training may be very time and content intensive and may require qualified trainers (or trainees) to travel to sites across the globe in order to train as qualified operators/users/trainers of the clinical instrument or piece of equipment. This mode of training is very expensive and time consuming. Moreover, the training may be administered inconsistently, as some trainers are certainly more adept at training than others, and it may be difficult to determine whether the training has been successfully administered. Accordingly, improved methods and systems of training individuals (trainees) in the operation, calibration, maintenance and/or troubleshooting of highly technical instruments (e.g., clinical instruments) or pieces of equipment may be desired.

### SUMMARY OF THE INVENTION

According to a first aspect, a web-based, training method for an instrument or piece of equipment is provided. The method includes providing a web-based portal operable on a server system and accessible by one or more trainees; providing an e-training module accessible by one or more trainees via the web-based portal, the e-training module including a collection of one or more e-training courses directed at attaining a competency on the instrument or piece of equipment; selecting one or more e-training courses from the collection of one or more e-training courses to generate an e-learning plan; engaging in learning with at least one of the one or more selected e-training courses, the learning involving completion of a knowledge portion and validation of completion of a practical portion; and generating at least one selected from the group of: a status report of the e-learning plan, a certificate of completion for at least one e-training course from the e-learning plan, and a transcript of at least some e-training courses from the e-learning plan.

According to another aspect, a web-based, training method for an instrument or piece of equipment is provided. The method includes providing a web-based portal operable on a server system accessible by a work group administrator; providing an e-training module on the server system and accessible by one or more trainees via the web-based portal, the e-training module being accessible by the one or more trainees to take one or more available e-training courses directed at attaining a level of competency on the instrument or piece of equipment; providing a system-generated invite to the one or more trainees to join a work group; and selecting one or more e-training courses from the one or more available e-training courses to assign an e-learning plan to the one or more trainees.

According to another aspect, a web-based, training system adapted to provide training on an instrument or piece of equipment is provided. The system includes a server system operable to provide a web-based portal accessible by one or more trainees; and an e-training module operable on the server system accessible by one or more trainees via the web-based portal, the e-training module including a content library sub-module containing a collection of one or more e-training courses directed at the instrument or piece of equipment, a trainee planner sub-module adapted to allow a trainee to select one or more of the e-training courses and generate an e-learning plan, a validation sub-module adapted to validate completion of a knowledge portion and validation of completion of a practical portion, and an output generator adapted to generate at least one output selected from the group of: a status report of the e-learning plan indicating a status of each selected e-training course of the e-learning plan, a transcript of all completed e-training courses from the e-learning plan, and a certificate of completion for at least one e-training course from the e-learning plan.

In another system aspect, a web-based, training system adapted to provide training on an instrument or piece of equipment is provided. The system includes a server system operable to provide a web-based portal accessible by a one or more work group administrators; and an administrator module operable on the server system and accessible by the one or more administrators, the administrator module including an invite sub-module adapted to provide a system-generated invite to one or more trainees to join a work group, and a planning sub-module adapted to allow the work group administrator to select one or more e-training courses from the one or more available e-training courses to assign an e-learning plan to the one or more trainees.

According to yet another aspect, a web-based, training system adapted to provide training on an instrument or piece of equipment is provided. The system includes a server system operable to provide web-based portals accessible by one or more trainees and one or more work group administrators; an e-training module operable on the server system and accessible by one or more trainees, the e-training module including a content library sub-module containing a collection of one or more e-training courses directed at the instrument or piece of equipment, a trainee planner sub-module adapted to allow a trainee to select one or more of the e-training courses and generate an e-learning plan, a validation sub-module adapted to validate completion of a knowledge portion and validation of completion of a practical portion, and an output generator sub-module adapted to generate at least one output selected from the group of: a status report of the e-learning plan indicating a status of each selected e-training course of the e-learning plan, a transcript of all completed e-training courses from the e-learning plan, and a certificate of completion for at least one e-training course which is completed from the e-learning plan; and an administrator module operable on the server system and accessible by the one or more work group administrators, the administrator module including: an invitation sub-module adapted to invite one or more trainees to a work group, and a manage team sub-module adapted to allow the one or more work group administrators to select and assign one or more e-training courses to the one or more trainees accepting the invitation to the work group.

According to yet another aspect, a non-transitory computer-readable medium adapted to operate on one or more computers is provided. The computer-readable medium includes storage media containing: an e-training module adapted to be accessible by one or more trainees, the e-training module including a content library sub-module containing a collection of one or more e-training courses directed at the operation, calibration, maintenance, control testing, or troubleshooting of an instrument or piece of equipment; a trainee planner sub-module adapted to allow a trainee to select one or more of the e-training courses and generate an e-learning plan; a validation sub-module adapted to validate completion of a knowledge portion and validate completion of a practical portion; and an output generator sub-module adapted to generate at least one output selected from the group of: a status report of the e-learning plan indicating a status of each selected e-training course of the e-learning plan, a transcript of all completed e-training courses from the e-learning plan, and a certificate of completion of one or more e-training courses from the e-learning plan.

In another aspect, a non-transitory computer-readable medium adapted to operate on one or more computers is provided. The computer-readable medium includes storage media containing: an administrator module adapted to be accessible by the one or more administrators, the administrator module including an invite sub-module adapted to generate an invite to one or more trainees to join a work group, and a planning sub-module adapted to allow the work group administrator to select one or more e-training courses from the one or more available e-training courses from a content library containing a collection of one or more e-training courses directed at the operation, calibration, maintenance, control testing, or troubleshooting of an instrument or piece of equipment to assign an e-learning plan to the one or more trainees.

According to another aspect, a non-transitory computer-readable medium adapted to operate on one or more computers is provided. The computer-readable medium includes storage media containing an e-training module accessible by one or more trainees, the e-training module including a content library sub-module containing a collection of e-training courses directed at attaining competency on an instrument or piece of equipment, a trainee planner sub-module adapted to allow a trainee to select one or more of the e-training courses and generate an e-learning plan, a validation sub-module adapted to validate completion of a knowledge portion and validate completion of a practical portion, and an output generator sub-module adapted to generate at least one output selected from the group of: a status report of the e-learning plan indicating a status of each selected e-training course of the e-learning plan, a transcript of all completed e-training courses from the e-learning plan, and a certificate of completion for at least one e-training course that is completed from the e-learning plan; and an administrator module accessible by the one or more work group administrators, the administrator module including: an invitation sub-module adapted to invite one or more trainees to a work group, and a manage team sub-module adapted to allow the one or more work group administrators to select and assign one or more e-training courses to the one or more trainees accepting the invitation to the work group.

According to yet another aspect, a computer-implemented training method is provided. The computer-implemented training method includes providing a portal accessible by one or more trainees; providing an e-training module accessible by the one or more trainees via the portal, the e-training module including a collection of one or more e-training courses directed at attaining one or more competencies; selecting one or more e-training courses from the collection of one or more e-training courses to generate an e-learning plan; and engaging in learning with at least one of the one or more selected e-training courses, wherein the learning involves completion of a knowledge portion and validation of completion of a practical portion with the e-training module whereby actual attainment of the competency is validated.

Still other aspects, features, and advantages of the present invention may be readily apparent from the following detailed description by illustrating a number of exemplary embodiments and implementations, including the best mode contemplated for carrying out the present invention. The present invention may also be capable of other and different embodiments, and its several details may be modified in various respects, all without departing from the spirit and scope of the present invention. Accordingly, the drawings and descriptions are to be regarded as illustrative in nature, and not as restrictive. The drawings are not necessarily drawn to scale. The invention is to cover all modifications, equivalents, and alternatives falling within the spirit and scope of the invention.

### BRIEF DESCRIPTION OF THE DRAWINGS

FIGS. 1A and 1B are illustrations of training approaches according to the prior art.

FIG. 2 is a block diagram illustration of a training method according to embodiments of the present invention.

FIG. 3 is a block diagram illustration of a training system according to embodiments of the present invention.

FIG. 4 is a block diagram illustration of an e-training module of the e-training system according to embodiments of the present invention.

FIG. 5 is a flowchart illustrating an e-training method according to embodiments of the present invention.

FIG. 5A is a screen shot of an exemplary welcome screen from which a trainee may access the e-training system according to embodiments of the present invention.

FIG. 5B is a screen shot of an exemplary registration screen for registering to gain access to the e-training system according to embodiments of the present invention.

FIG. 5C is a screen shot of an exemplary test screen for enabling a test to ensure system requirements are met for the e-training system according to embodiments of the present invention.

FIG. 5D is a screen shot of an exemplary tutorial screen for enabling a tutorial of the e-training system according to embodiments of the present invention.

FIG. 5E is a screen shot of an exemplary content library screen of a content library sub-module of the e-training system according to embodiments of the present invention.

FIG. 5F is a screen shot of a listing of instruments or equipment-specific e-training courses from the content library of the e-training system according to embodiments of the present invention.

FIG. 5G is a screen shot of an exemplary planner screen of a planner sub-module for enabling a trainee to view and select from the available training areas and competencies of the e-training system according to embodiments of the present invention.

FIG. 5H is a screen shot of an exemplary guidebook screen for enabling a trainee to view statistics in regards to the trainee's e-training according to embodiments of the present invention.

FIG. 5I is a screen shot of an exemplary guidebook of the e-training system illustrating the knowledge, practical, and validation portions of the e-learning method and system according to embodiments of the present invention.

FIG. 5J is a flowchart of an exemplary training method of the e-training system according to embodiments of the present invention.

FIG. 5K is a screen shot of an exemplary practical exercise validation screen of the e-training system according to embodiments of the present invention.

FIG. 5L is a screen shot of an exemplary report screen of the e-training system according to embodiments of the present invention.

FIG. 5M is a screen shot of an exemplary certificate of completion which may be generated by the e-training system according to embodiments of the present invention.

FIG. 6 is an illustration of an administrator module according to embodiments of the present invention.

FIG. 7 is a flowchart illustrating an exemplary method which may be undertaken by an administrator according to embodiments of the present invention.

FIG. 7A is a screen shot of an exemplary welcome screen from which a work group administrator may access the e-training system according to embodiments of the present invention.

FIG. 7B is a screen shot of an exemplary registration screen for registering to gain access to the e-training system according to embodiments of the present invention.

FIG. 7C is a screen shot of an exemplary tutorial screen for enabling a tutorial of the functions of administrator module of the e-training system according to embodiments of the present invention.

FIG. 7D is a screen shot of a manage team screen of an exemplary manage team sub-module of the e-training system according to embodiments of the present invention.

FIG. 7E is a screen shot of an invite screen sent by the e-training system according to embodiments of the present invention.

FIG. 7F is a screen shot of an unpopulated planner screen of the e-training system according to embodiments of the present invention.

FIG. 7G is a screen shot of a populated planner screen of the e-training system according to embodiments of the present invention.

FIG. 7H is a screen shot of an unpopulated report screen of the e-training system according to embodiments of the present invention.

FIG. 7I is a screen shot of an unpopulated report screen of the e-training system illustrating an open or save option according to embodiments of the present invention.

FIG. 7J is a screen shot of an populated report screen of the e-training system according to embodiments of the present invention.

FIG. 8 is an illustration of a content manager module according to embodiments of the present invention.

FIG. 9 is flowchart of a method adapted to manage a content of the e-training system according to embodiments of the present invention.

FIG. 9A is a screen shot of an access web page of the content manager sub-module according to embodiments of the present invention.

FIG. 9B is a screen shot of a page of a manage training area sub-module according to embodiments of the present invention.

FIG. 9C is a screen shot of a create/edit page of the manage training area sub-module according to embodiments of the present invention.

FIG. 9D is a screen shot of a page of a manage topics sub-module according to embodiments of the present invention.

FIG. 9E is a screen shot of a create/edit page of the manage topics sub-module according to embodiments of the present invention.

FIG. 9F is a screen shot of a page of a manage competencies sub-module according to embodiments of the present invention.

FIG. 9G is a screen shot of a create/edit page of the manage competencies sub-module according to embodiments of the present invention.

FIG. 9H is a screen shot of a page of a manage objects sub-module according to embodiments of the present invention.

FIG. 9I is a screen shot of a create/edit page of the manage objects sub-module according to embodiments of the present invention.

### DETAILED DESCRIPTION

On or in clinical instruments or equipment, many complex testing and/or processing tasks may be accomplished. For example, instruments such as automated clinical chemistry analyzers may have throughput of up to several thousand tests per hour or more and are capable of rate and end-point photometry, turbidimetry, potentiometry and the like. For example, clinical chemistry analyzers may accomplish assays (e.g., turbidimetric assays) for various proteins. Such proteins may include IgG, IgA, IgM, transferrin, haptoglobin, prealbumin, apolipoproteins (apo) A1 and B, and complements C3, C4. Other analytes and proteins may be tested for, as well. Furthermore, clinical analyzers may perform serology testing which refers to the diagnostic identification of antibodies in the serum. Hematology analyzers may be used to test various blood products.

In other cases, an instrument or piece of equipment may simply perform a process peripheral to, or previous to, a clinical analysis step. For example, the instrument or piece of equipment may be involved in sample preparation, reagent preparation, centrifuging, or other pre-analysis processing steps.

Such clinical instruments and equipment may be computerized, relatively complex to operate, and training on such instruments by individual trainees may be very labor intensive, costly, and time consuming. Moreover, direct, face-to-face training of the trainee on such instruments may be inefficient as the clinical instrument or equipment may be out of service during such training.

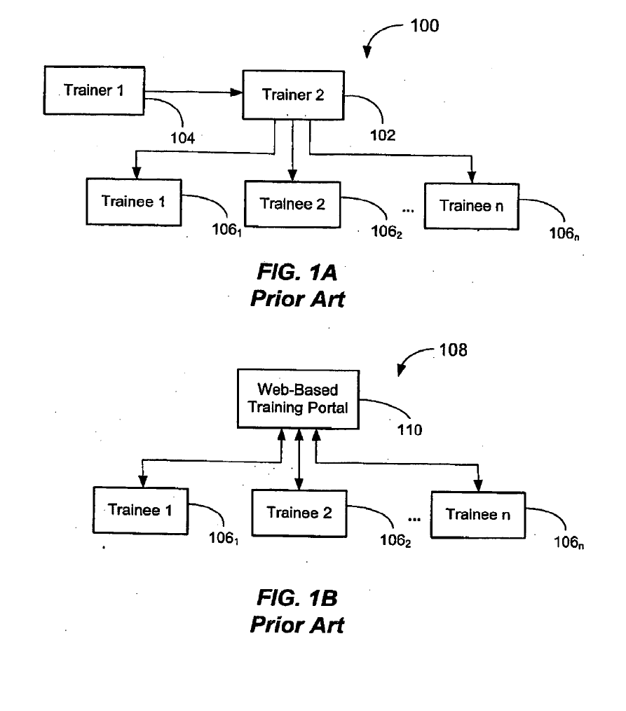

In many cases, such training may be accomplished by the so-called “train-the-trainer” approach. In this approach 100, as shown in FIG. 1A, a trainer 102 may receive intensive training from another qualified trainer 104 who is an employee or agent of the instrument manufacturer. Such intensive training may take four to six months or more. After being appropriately trained and certified, the trainer 102 may proceed to train a staff of trainees 106₁, 106₂, . . . , 106ₙ in the intricacies of the operation of the instrument or piece of equipment.

This “train-the-trainer” approach 100 may be further supplemented with an on-line training approach 108 for the trainees 106₁, 106₂, . . . , 106ₙ on a web-based training portal 110 wherein one or more web-based training courses may be taken. In existing on-line training methods 108, the trainees 106₁, 106₂, . . . , 106ₙ may enter the web-based training portal 110, select a prerecorded and stored training course from a listing of training courses, and then complete the training course either on line, or by downloading and completing the training course at the trainee's location. The training courses may include, for example, a course providing an overview of the operation of a particular instrument or piece of equipment. Such training courses may be either interactive web-based or video. The web-based training portal 110 may include the ability to search the courses offered and/or view a course catalog. Such course offerings may, of course, be offered for profit. Following the completion of the training, a certificate of completion may be issued to the trainees 106₁, 106₂, . . . , 106ₙ. Such certificates may be printed out by the trainees 106₁, 106₂, . . . , 106ₙ.

Additionally, training in the specifics of operation, maintenance, and troubleshooting of an instrument or piece of equipment may involve one or more trainees visiting a training center wherein they may undergo intensive hands-on training and/or training in the theory of operation on a specific instrument or piece of equipment.

Once the training has been completed, it is desired that the trainees 106₁, 106₂, . . . , 106ₙ would be fully trained in all aspects of operation, calibration, maintenance, quality control, and troubleshooting of the instrument or piece of equipment. However, when such train-the-trainer approaches are used, information may be lost or errors may be made in the training transfer process. Furthermore, having to include such competent trainers within the company staff of the instrument/equipment operator is very expensive. Moreover, not all operators need to be trained to the same level.

Furthermore, such prior art training approaches, as discussed above, may be limited in effectiveness, and/or may be very time consuming and expensive to implement. For example, the training centers may include many computers, numerous instructors (trainers), and may require additional instruments or equipment on which the trainees may train, and which may not be used for clinical testing of actual patent specimens. Additional travel and/or boarding expense may be associated with such training at training centers. Moreover, such training may take the trainee away from the testing facility, possibly for extended periods of time. Furthermore, existing web-based approaches do not adequately meet the needs of operators who have different levels of competencies, and may be generally ineffective.

In view of the foregoing problems, the present invention provides improved web-based, e-training methods and systems. According to a first aspect, the invention is directed at a single-source, e-learning/training platform adapted for the delivery, assessment, tracking, and reporting of educational needs of trainees. In particular, the present invention has excellent utility for providing a web-based, e-learning/training platform adapted for delivery, assessment, tracking, and reporting of educational needs relating to attaining competency in one or more areas of a specific instrument or piece of equipment. According to aspects of the invention, the web-based, e-learning/training method may be instrument specific; the web-based, e-learning may be either trainee and/or administrator defined; and the web-based, e-learning may be, in particular, competency based. Competency-based training provided in accordance with aspects of the invention ensures that the trainee meets certain learning goals for that e-training course and is competent to carry out that learning in real-world applications.

In some embodiments, an individual trainee may, in an e-training module, define their individual competency-based training plan, and engage in web-based, e-training. The competency-based training may be based upon their job role, level of experience, knowledge, and/or their intended career path. The e-training module may allow the user to plan, track, and/or manage their instrument-specific, competency-based e-training, as well as generate and/or view their accreditation status, CEU (certified educational unit) certificates of completion, and/or renew their eligibility to operate a particular instrument or piece of equipment (e.g., yearly). Furthermore, the individual trainee may generate for viewing (e.g., through screen display, download, or printing) a status report or transcript over a particular time frame of their accreditation. Such certificates and transcripts may be securely stored and accessed by the trainee, even if the trainee changes employment locations. Accordingly, the proof of accreditation and certification is less prone to being lost and is fully portable.

In another aspect, a web-based, e-learning plan may be established and set for one or more trainees by an administrator. The administrator may be a work group administrator, and may be responsible for establishing and tracking e-learning plans and status of trainees who are members of the work group. This web-based, e-learning plan may also be viewed and tracked by the trainee. Accordingly, the present invention may provide a single-source platform for delivery and tracking of an instrument or equipment user's educational training and accreditation needs.

Competency in any e-learning area of the e-training course may be established by the method by utilizing e-training courses having combinations of e-learning content, practical application of the e-learning content, and testing.

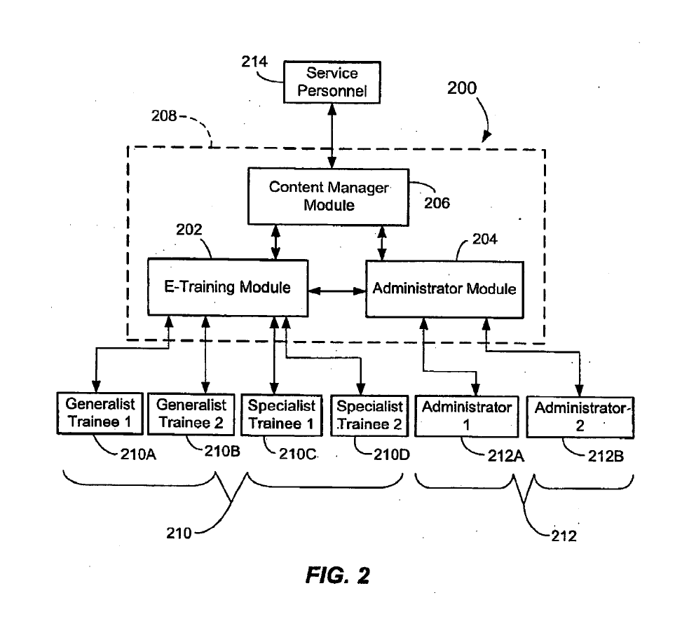

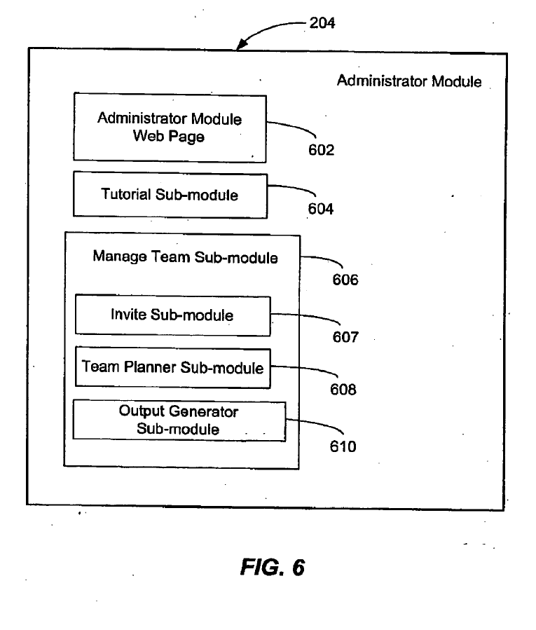

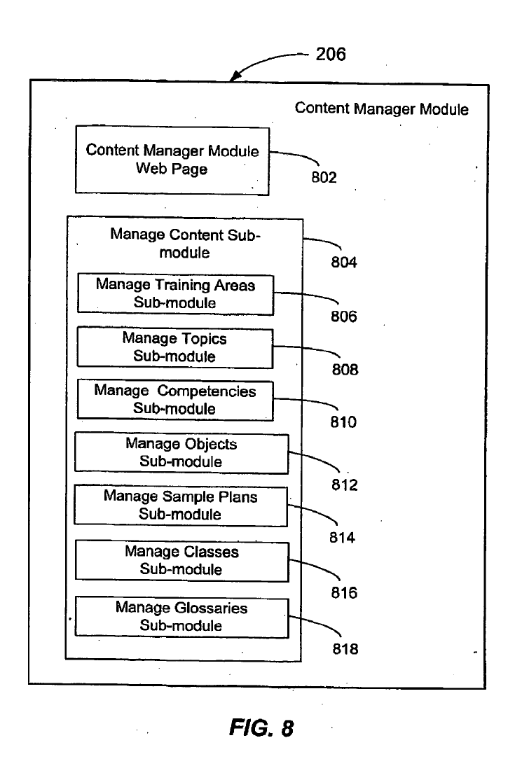

These and other aspects and features of the invention will be described with reference to FIGS. 2-9I herein.

In accordance with a first embodiment of the invention, as best shown in FIG. 2, a web-based, e-training system 200 is described. The web-based, e-training system may be referred to herein as the “web-based, e-training system,” the “e-training system,” or simply the “system.” The web-based, e-training system 200 is useful for aiding in the training of individual trainees on various aspects of the theory, operation, maintenance, calibration, control testing and/or troubleshooting of a particular instrument or piece of equipment. The method and system are applicable for instruments such as clinical analyzers or processing systems associated therewith. However, the method and apparatus are equally applicable for other types of technical instruments or pieces of equipment.

In the depicted embodiment, the e-training system 200 includes an e-training module 202, an administrator module 204, and a content manager module 206. The modules 202, 204, 206 may be accessed via the internet via a web page portal 208 (shown dotted) operating on a server system. The content and operation of the web site may be managed by the instrument or equipment manufacturer or an agent thereof. Each module may include various sub-modules for carrying out various functions. “Module” as used herein means any executable code or program or collection of codes or programs adapted to carry out a function. The module may be executed on one computer or processor or more than one. “Sub-module” as used herein means any executable code or program or collection of codes or programs adapted to carry out a sub-function of a module wherein a module may include more than one sub-module.

The web page portal 208 of the system 200 may be accessed by one or more trainees 210, one or more administrators 212, and one or more service personnel 214 using known web browser technology, such as FireFox, Google Chrome, Internet Explorer, Safari, or the like. The e-training system 200 may be provided as a computer-readable medium resident on a server system. The server system may include one or more servers, for example. The term “e-training” as used herein means training that is administered by a trainee engaging a computer and wherein the e-training courses are stored electronically.

### Training Module

Now referring to FIGS. 2-5J, the structure and function of the e-training module 202 and method 500 will be discussed in more detail. The e-training module 202 may be accessible by one or more individual trainees 210 who are in need of e-training in relation to the operation, calibration, maintenance, quality control, and/or troubleshooting of a particular instrument or piece of equipment. Similarly, the administrator module 204, to be described in detail below, may be accessible by one or more administrators 212 through a web portal 208. Also, the content manager module 206, to be described in detail below, may be accessible by one or more service personnel 214 through a web portal 208. According to one aspect of the invention, in some embodiments, the one or more trainees 210 may utilize a planner to select and/or set a content of their individual e-learning plans. In other embodiments, the one or more administrators 212, each of which may be a work group administrator of a specific work group that is utilizing one or more instruments or pieces of equipment, may be responsible to select and/or set an e-learning plan for one or more trainees within their work group.

The e-learning plan may be specific to a particular instrument or piece of equipment utilized within the work group. The e-learning plan may be competency-based and specific to the one or more individual trainees 210, and may be directed at achieving certain desired (e.g., minimum) competency for those individual trainees 210 on a particular training area for a particular instrument or piece of equipment. Competency-based training means that each training area is broken down by the number of e-training competencies to be achieved. These may be individual e-training courses each directed at a specific aspect of the operation, calibration, maintenance, quality control and troubleshooting of the instrument or piece of equipment.

According to further aspects of the invention, the training system 200 may be configured and adapted to provide specific e-training plans and e-training to the individual trainees 210 who may each be in need of training that is different in subject matter content and/or intensity. For example, the training module 202 of the e-training system 200 may provide user-specific e-training to individual trainees of different skill levels, job roles, and/or job titles. For example, one or more generalist trainees, such as generalist trainee 1 (210A) and generalist trainee 2 (210B) may be trained in the training module 202 on a few competencies of a general operation of a particular instrument or piece of equipment. However, if more intensive training is required/desired, the e-training module 202 may provide suitable e-training in more competencies for a specialist trainee 1 (210C) or specialist trainee 2 (210D) who may be in need of training to a higher set of competencies. Examples of competencies include setup of the instrument or piece of equipment, programming of the instrument or piece of equipment, daily setup of the instrument or piece of equipment, sample processing on the instrument or piece of equipment, insufficient sample processing on the instrument or piece of equipment, sample management on the instrument or piece of equipment, and the like. Each competency completed may provide an incremental or increasing level of skill in a particular training area of operation, calibration, maintenance, quality control, and/or troubleshooting of the instrument or piece of equipment. Accordingly, the e-training provided by the training module 202 may be suitable for individual trainees 210 at different levels of skill and competency requirements.

Additionally, the e-training may be accessed from multiple locations, such as where the instrument or piece of equipment and the individual trainees 210 are located. Furthermore, where a customer of a particular line or model of instrument or piece of equipment may have multiple locations, e-training may easily be accomplished at each such location. Also, where there are multiple customers of the particular line or model of instrument or piece of equipment, the training module 202 may provide those individual customers access to e-training which may be trainee-defined, administrator-defined, or both. Furthermore, the e-training system 200 allows the customer to establish and track (e.g., monitor) e-training and certification for all of their trainees 210 in instances where the trainee must undergo continuous training and certification.

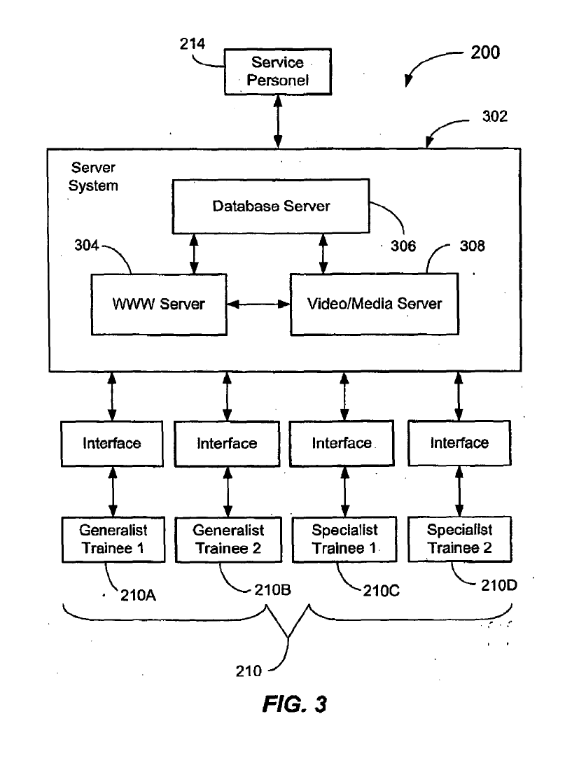

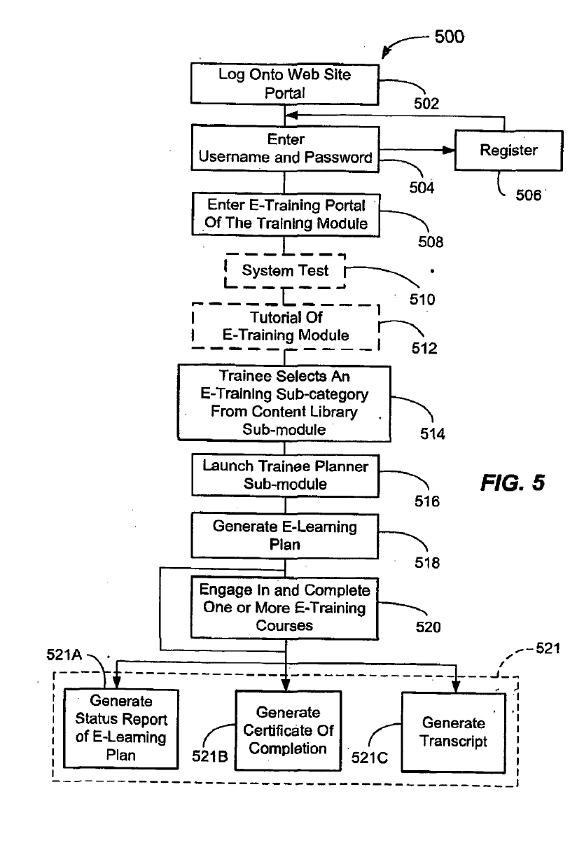

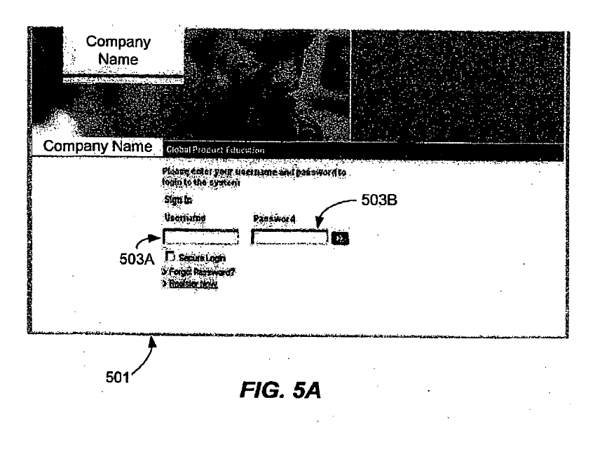

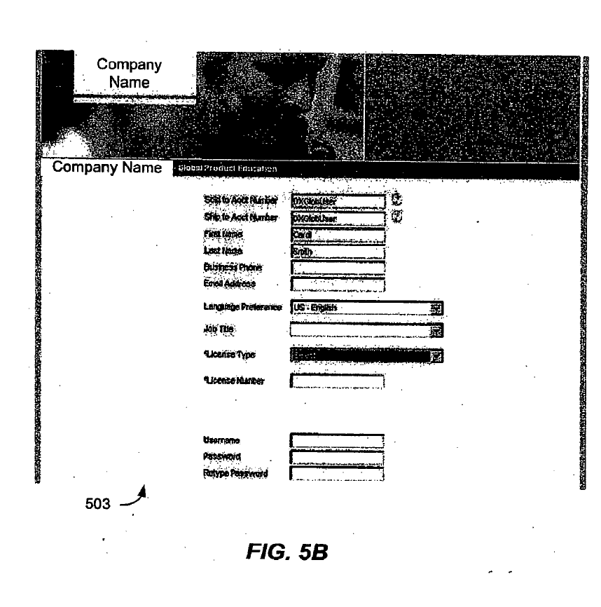

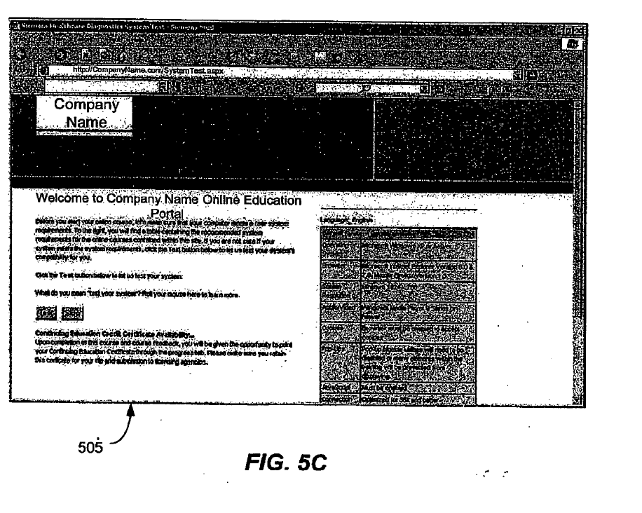

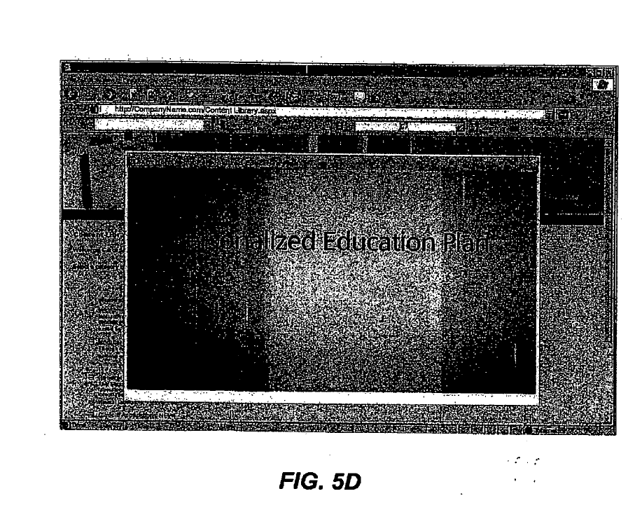

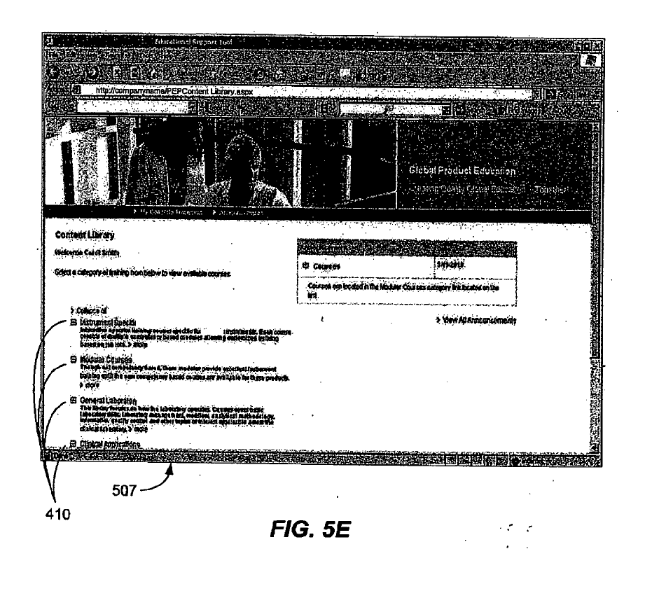

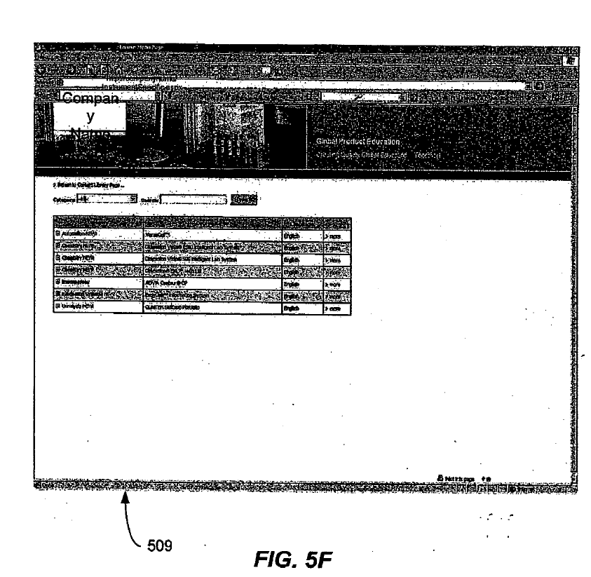

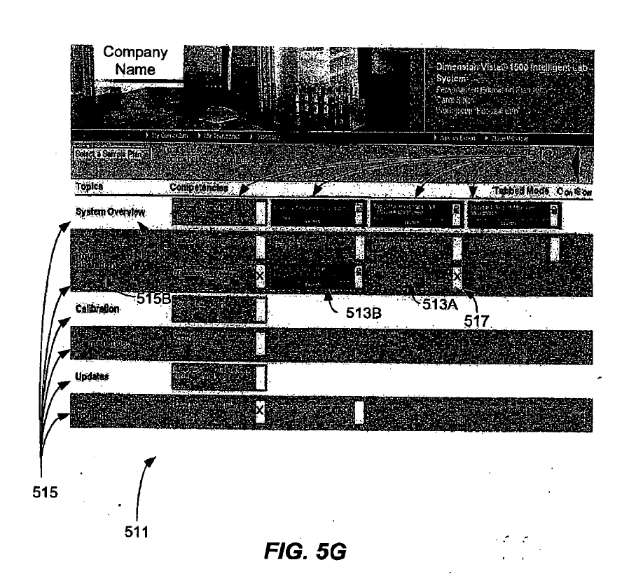

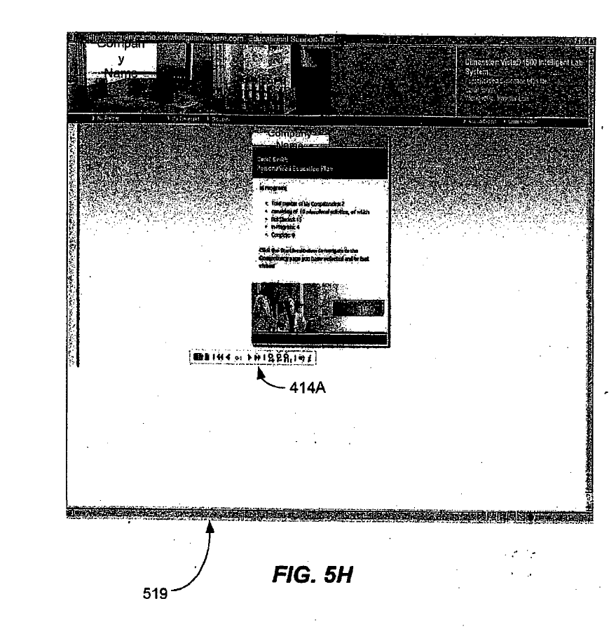

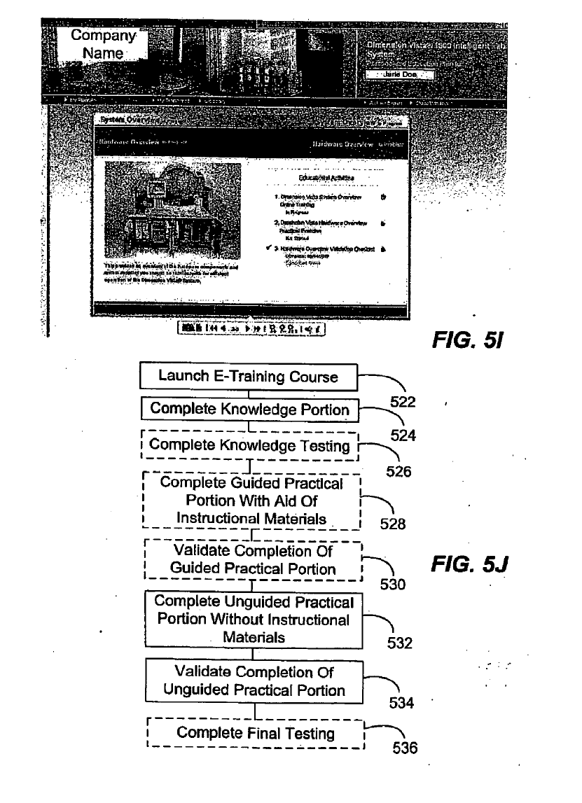

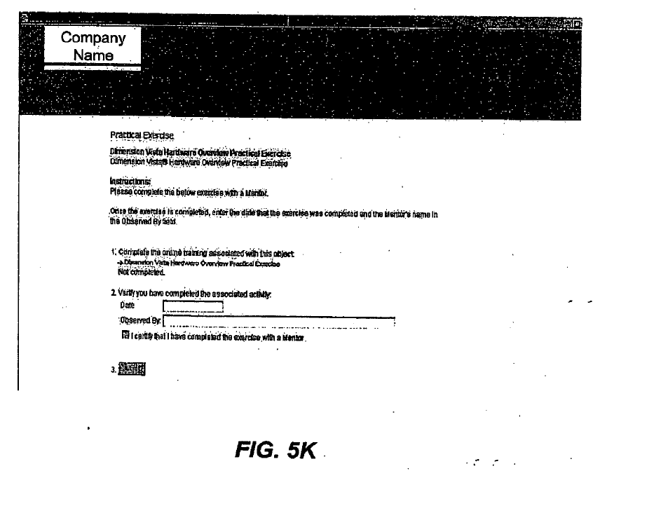

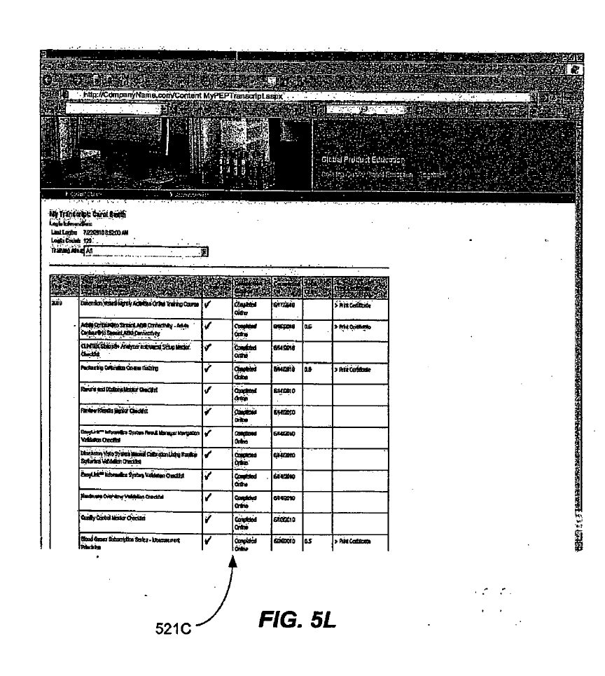

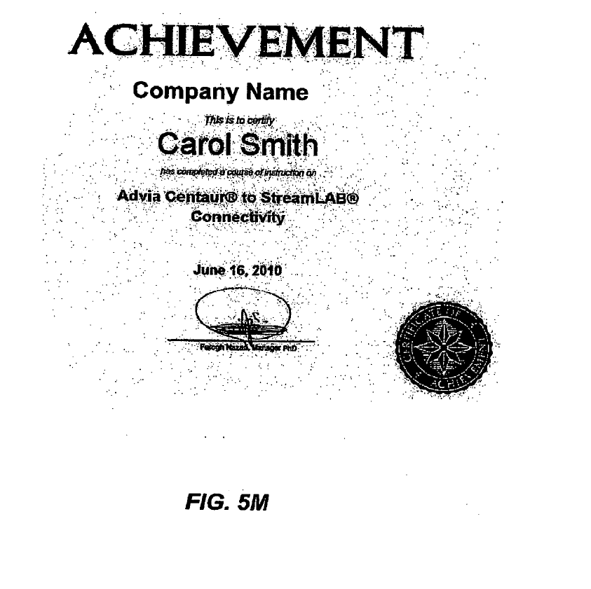

The operation of the present invention training method in regards to the trainee will now be described in more detail with reference to FIGS. 3-5J. According to the e-training method 500, as illustrated in FIG. 5, a trainee 210A (e.g. generalist trainee 1) may first log onto the web site portal 501 in block 502 by typing in the web address (e.g., www.companytraining.com). A suitable screen shot of a web site portal 501 is shown in FIG. 5A. The web site portal 501 may be administered by the instrument or equipment manufacturer, or an agent thereof. Web access may be provided by any suitable server system, such as a server system 302, which may include several integrated servers. The number and size of the servers of the server system 302 will depend largely upon the amount of content and number of trainees and administrators accessing the system, as well as the complexity of the e-training courses stored thereon. The server system 302 may employ numerous dedicated server machines, such as a collection of servers in one location (e.g., a server farm). If very heavy traffic is expected, load balancing may be employed to distribute the requests among the various servers so that no single machine is overwhelmed. Any suitable server operating system may be used, such as MICROSOFT® SQL SERVER, MICROSOFT® WINDOWS SERVER 2003, or the like. Any suitable version control may be used such as SOURCE GEAR VAULT. WWW server 304 (e.g., a web server) may be adapted to control access to the web portal 208 and access to the e-training module 202, administrator module 204, and content manager module 206 (see FIG. 2). The WWW server 304 may be one or more computers that actually run the web site together with software that runs on the one or more computers, accepting HTTP connections from web browsers and delivering web pages and other files to them, as well as processing form submissions. The user interface may be provided by MICROSOFT® ASP.net, for example.

The WWW server 304 may store some files related to the web site and may serve (i.e., send) the files across the internet via web browsers, such as when requested by a trainee (e.g., 210A). The web server program may be Microsoft-IIS, Apache, RomPager, or the like. At the web page portal 501, the trainee (e.g., 210A) may be granted access to the training module 202 by entering a suitable username 503A and password 503B at the in block 504. If the trainee (e.g., 210A) has already registered, then a username and password has already been established and granted. Otherwise, the trainee (e.g., 210A) must be registered in registration block 506. Registration involves obtaining trainee information. Such information may be obtained directly from the trainee (e.g., 210A) at the registration step 506, by being registered by an administrator 212, or by e-mail or phone contact with service personnel 214 pending receipt of suitable authorization. An example of a registration page 503 is shown in FIG. 5B.

Such information and data obtained or generated by the trainee (e.g., 210A), administrator 212, or service personnel 214 may be stored on a database server 306. Any suitable database program may be operative on the database server 306, such as MICROSOFT® SQL SERVER, MICROSOFT® ACCESS, ORACLE, DB2, MICROSOFT® FILEMAKER, or the like. Proper entry allows the trainee (e.g., 210A) to enter into the e-training portal 402 of the training module 202 in block 508. A screen shot of a welcome screen 505 to the e-training module 202 is shown in FIG. 5C.

Once at the welcome page 505, the trainee (e.g., 210A) may be optionally offered to test their computer system (“system test”) in block 510 by clicking on a radio button or the like to execute a test routine sub-module 404 of the e-training module 202. The system test sub-module 404 may ensure that the computer the trainee is using for interacting with the e-training module 202 includes suitable system requirements. Such requirements may depend on the programs being used. However, in some embodiments, the operating system may include MICROSOFT® WINDOWS® XP or newer, the web browser may be MICROSOFT® INTERNET EXPLORER® VERSION 6.0 or 7.0, or MOZILLA FIREFOX Version 1.5, the screen resolution may be 1024×768 dpi minimum, audiovisual may include MICROSOFT® WINDOWS® MEDIA PLAYER 9 or newer, and the connection may be enabled for 56K baud rate or higher. Additionally, the web browser may be enabled to accept cookies, and the pop-up blocker may be disabled. The system test may be carried out using any suitable system check software, such as BROWSERHAWK® available from cyScape, Inc. of Rockville, Md.

Additionally, a tutorial of the E-Training Module 202 may be offered in block 512 by executing the tutorial sub-module 406. The tutorial may take the form of a prerecorded and standardized video presentation, for example. One suitable format for the video is shown in the screen shot of FIG. 5D where a pop-up screen displays the tutorial materials. Other forms of tutorials may be included, such as a number of slides, etc. The tutorial in 512 may cover at least some of the key functions of the e-training module 202, such as the trainee planning function, the administrator training function, the content library, and the output generator function. The tutorial may be declined by the trainee (e.g., 210A), or offered only when the trainee (e.g., 210A) enters the e-training module 202 for the first time.

Next, at the content library sub-module 408, the trainee (e.g., 210A) may select from a group of sub-categories of e-training 410. An exemplary screen shot of a display screen 507 of the content library sub-module 408 is shown in FIG. 5E. The particular sub-categories of e-training 410 may include any of the following:
instrument or equipment specific courses (e.g., model specific courses), and in particular, competency-based courses directed at one or more competencies on an instrument or piece of equipment
modular courses (e.g., on general instrument or equipment knowledge)
general laboratory operations courses (e.g., on general laboratory knowledge)
clinical application courses

Those instrument or equipment specific e-training courses may be specific to a particular instrument or piece of equipment and each may be directed at a single specific competency for the instrument or piece of equipment. An individual competency is a subset of the total training competencies needed to be able to fully operate all the features, as well as to maintain, calibrate, perform quality control testing, and troubleshoot a particular instrument or piece of equipment. The modular courses may be directed at general knowledge directed towards understanding a particular instrument (e.g., broad overviews). The general laboratory courses are broad overviews of core knowledge of a particular area, such as: laboratory skills, laboratory management, laboratory work flow, analytical methodologies, informatics, quality control methodologies, and the like. The clinical laboratory courses are directed at knowledge in the array of assaying processes and methods and the theory behind them.

Once in the content library sub-module 408, the trainee (e.g., 210A) may then refer to the listing of one or more of the sub-categories of e-training 410 in the content library sub-module 408, and select an e-training sub-category 410 in block 514. This will bring up a listing of the collection of e-training courses. A screen shot 509 of a listing of available e-training courses for the instrument or equipment specific sub-category is shown in FIG. 5F. As can be seen, the listing may be organized by the trade name of the instrument or piece of equipment. The trainee (e.g., 210A) may then drill deeper by selecting a particular instrument or piece of equipment from the listing via selecting “>more”. Once a trainee selects a particular instrument or piece of equipment, a trainee planner sub-module 412 may be launched in block 516. The launch may be automatic or via the selection of a selection box indicating to launch the trainee planner sub-module 412 together with the selection of a training sub-category. A screen shot of the display screen 511 of the trainee planner sub-module 412 is shown in FIG. 5G.

The trainee planner sub-module 412 may include a listing of all the available e-training courses 513 available for a particular instrument or piece of equipment. The listing of e-training courses 513 may be organized by competency. For example, the competencies may include one or more competency areas 515 selected from a group of competency areas consisting of: routine operation of the instrument or piece of equipment (“Routine Operations”), calibration of the instrument or piece of equipment (“Calibration”), maintenance of the instrument or piece of equipment (“Maintenance”), software updates to an instrument or piece of equipment (“Updates”), and quality control processing of the instrument or piece of equipment (“Quality Control”). Accordingly, a trainee (e.g., 210A, 210B) who may be a generalist operator may only need to become proficient at only certain competencies in the areas of Routine Operations and Quality Control, for example. As such, the generalist trainee 210A may generate an e-learning plan in block 518 whereby the generalist trainee 210A may only select a subset of the total competency-based e-training courses that are available for the specific instrument or piece of equipment.

On the other hand, a specialist trainee (e.g., 210C, 210D) may be required to be proficient in a broader number of competency areas 515 (possibly all areas of competency) for the particular instrument or piece of equipment. Accordingly, the specialist trainee (e.g., 210C, 210D) may select and generate an e-learning plan in block 518 that may include e-training courses 513 from a relatively broader number of the competency areas 515 and competencies for the particular instrument or piece of equipment.

Each competency area 515 for each particular instrument or piece of equipment may include one or more e-training courses 513. For example, the System Overview competency 515A may include several different overview e-training courses on different technical areas, such as hardware overviews, software navigation, etc. that are directed at providing an overview of selected competencies related to the particular instrument or piece of equipment. Similarly, the Routine Operations competency 515B may be broken down into a number of e-training courses on various competencies of the routine operation of the particular instrument or piece of equipment.

At the trainee planner sub-module 412, a screen shot of which is shown in FIG. 5G, the trainee may select any number of e-training courses 513 to complete by selecting a selection icon, such as selecting a check box 517. An icon (e.g., an X) may appear in the check box 517 as it is selected by the trainee to indicate that the e-training course (e.g., 513A) is selected. As can be seen, several courses have been selected by the trainee (e.g., 210A). Additionally, several of the e-training courses 513 may have been pre-selected for the trainee (e.g., 210A) by a work group administrator. These e-training courses (e.g., 513B) may be shown as containing a picture icon of a lock in the check box thereof. Other suitable icons may be used. These e-training courses (e.g., 513B) may be selected for the trainee, such as by a work group administrator for the work group that the trainee belongs to, as will be described in more detail below.

At any point in the process after generating the e-learning plan via accessing the trainee planner sub-module 412, the trainee may launch or select a guidebook sub-module 414. The guidebook sub-module 414 may allow the trainee to track and review a status of their competency-based, e-learning plan. In particular, the guidebook function may simply access information from the database that has been populated with data on the database server 306 with the status (e.g., not started, in process, completed) of various selected e-training courses selected by, or assigned to, the trainee. The guidebook sub-module 414 may include functionality that allows the trainee to view, for example, status of the various e-training courses of the e-learning plan, such as on a numerical basis. Each page of the book may relate to a selected e-training course. For example, one or more of the following may be listed: a total number of competencies selected and assigned, a total number of educational activities (e-training courses) which have been selected and assigned, and a total number of the educational activities (e-training courses) that fall into one or more status categories. The status categories may include one or more selected from a group of categories consisting of not started, in progress, and complete. A number for each category may be listed next to the category. A screen shot of a page 519 of the guidebook sub-module 414 is shown in FIG. 5H. A trainee may also have other e-learning plans which have been established for other instruments or pieces of equipment or other competency areas and the trainee may page through those pages using the guidebook controls 414A. The guidebook functionality may be provided using ADOBE® FLASH®, for example. However any book simulation software may be employed. Additional graphics for the various screen shots and web pages may be generated in ADOBE® PHOTOSHOP® and ILLUSTRATOR®.

From the guidebook screen, the trainee may engage in and complete one or more of the selected or assigned e-training courses 513 from the trainee's e-learning plan in block 520. Each of the e-training courses 513 may be administered by selecting the particular e-training course from a page of the guidebook and completing the e-training course.

In more detail, when the trainee first selects “start” from the guidebook (see FIG. 5H), this may display the e-training course activities for the selected e-training course. The activities may include a knowledge portion, a practical portion (e.g., practical exercise portion), and a validation portion. The knowledge portion may be a video, a series of slides, or an animation wherein specific information (learnings) are presented for assimilation by the trainee. The trainee first launches the e-training course by selecting in block 522 the knowledge portion (Online training) of FIG. 5J. After the trainee has completed the knowledge portion in block 524, by interfacing with the server via a computer, the trainee may take a computer-implemented test (e-test) on the knowledge presented in block 526. A passing grade on the knowledge portion may be passed on to the database. However, it should be understood that the test may be optional. Validation of the completion of the learning portion may be by the trainee indicating completion by submitting an e-verification (e.g., clicking on a completed button), or simply by the knowledge portion being played to its end.

Once the e-learning activity (knowledge portion) is completed, the trainee may undergo a practical portion. This may include hands-on training with the assistance of, or in view of an observer or mentor. This may involve a guided practical exercise portion in block 526. The guided practical exercise may involve hands-on involvement with the instrument or piece of equipment. However, in a first aspect, the hands-on involvement may be instruction driven, i.e., the trainee may be provided with a precisely-written or conveyed set of instructional materials or steps that the trainee is instructed to complete with respect to the instrument or piece of equipment. The completion of the guided practical portion in 528 may be witnessed by an observer (e.g., a mentor) trained on the instrument or piece of equipment. Once completed, an e-validation of the guided practical portion may be completed in block 530 in validation sub-module 416. The e-validation is achieved through interfacing with the database to register that not only was the knowledge portion completed via the trainee verifying they completed the e-learning (knowledge portion), but that the practical portion was also completed. The trainee validates that the guided practical portion has been completed by submitting an e-verification to the e-training system 200. The e-verification may include submitting the date of completion and the name of the observer at a submission page (See FIG. 5K) of the validation sub-module 416.

Next, the trainee may engage in an unguided practical portion in block 532. The unguided portion of the practical exercise may involve the trainee taking the practical exercise under the witness of an observer (e.g., mentor), but without the use of any instructional materials. This tests the competency of the trainee to the fullest extent, in that the trainee must complete the practical exercise without any training aids or assistance. Once the unguided practical portion is completed, the validation of completion of the unguided portion may be provided to the validation sub-module 416 in block 534 (FIG. 5J). This may involve signoff of a checklist by the observer (e.g., mentor) trained on the instrument or piece of equipment and that personally witnessed the practical exercise. Furthermore, the validation in 534 may involve submitting the date of completion and the name of the observer to the validation sub-module 416, in a manner similar to that described for the guided portion.

This validation information is then added to the database and may be displayed on the guidebook and elsewhere. Thus, it should be apparent that the present training method requires an e-knowledge portion, and a practical portion followed by e-verification of completion of the practical portion. Finally, there may be a final test or quiz provided in block 536 wherein the trainee must pass with an acceptable grade, or retake at least portions of the course until an acceptable grade is achieved in the e-training course. This final test may be optional. The validation steps above may be consolidated in some embodiments. Moreover any written tests may be administered at any stage in the process and possibly at multiple stages.

Following sufficient completion of all steps, the trainee may print off a certificate of completion and CEUs (if available for the e-training course) may be registered to the trainee by populating appropriate locations in the database. Accordingly, completion of the e-training according to the present method includes a combination of e-knowledge training, hands-on practical exercises (e.g., guided and/or unguided), and verification/validation of each step in the system 200, and ensures that the trainee has, in fact, actually achieved the competency sought to be attained by taking the e-training course.

According to another aspect, the trainee may, from a transcript screen of an output generator sub-module 418 generate one or more outputs in block 521. In FIG. 5, these outputs may be provided in any suitable format such as a downloadable file (e.g., a .pdf file) or in printed format. In some embodiments, the one or more generated outputs in block 521 may be one or more selected from a group consisting of: generation of a status report of the e-learning plan in block 521A, a transcript of the completed e-training courses from the e-learning plan in block 521B, or a certificate of completion of an e-training course in block 521C. An example of a certificate of completion is shown in FIG. 5M. As shown in FIG. 5L, a drop-down menu may be employed to select from the various training areas. The transcript may be arranged by year or by specific instrument or piece of equipment to which it pertains. A screen shot of a transcript output 521C from the output generator module 418 is shown in FIG. 5L. In the transcript 521C, a progress status of each e-training course 513 may be displayed, along with completion method and completion date. If the e-training course has been completed, the electronic transcript may be populated with a read-only certificate link, which may be used to download and/or print a certificate of completion for the completed e-training course. A number of CEUs for each e-training course may also be listed. In this way, a permanent record of all completed e-training courses are provided in the instrument manufacturer's (or their agent's) database. This record and transcript may be utilized for verification of a trainee's training status at any point in time. This transcript function may also be utilized for verification of a trainee's certification and/or accreditation status at any point in time. The transcript function may also be provided by utilization of MICROSOFT® ASP.net.

### Administrator Module

The administrator module 204 will now be described in detail in relation to FIGS. 2-3 and FIGS. 6-7I. The administrator module 204 is adapted and functions to allow an administrator, generally a trainee's supervisor, to view a status of the trainee's e-learning plan, and/or to establish or set an e-learning plan for the trainee. The training plan set by the administrator may be directed at achieving certain competencies for the trainee. These competencies may be in regards to a particular instrument or piece of equipment on which it is desired that the trainee become proficient. For example, it may be desirable that the trainee gain certain competencies in respect to an operation, maintenance, calibration, quality control testing and/or troubleshooting of a particular instrument or piece of equipment.

In some embodiments, the administrator may be an administrator for a specific work group (hereinafter the “Work Group Administrator” or “WGA”). A work group is a collection of personnel who are organizationally aligned. This may be through having related functions, a common manager, or same or similar job role or title. In this instance, the WGA may be responsible for generating and assigning e-learning plans for each trainee. To do so, the WGA may wish to add one or more trainees as a member of their work group. Each work group may contain numerous trainees who may be resident at one or a number of dispersed facilities where the instrument or piece of equipment is located. The WGAs may be employees from numerous purchasers of an instrument or a piece of equipment. Thus, the training system and method may allow multiple purchasers of the instruments and/or pieces of equipment to access centralized training for their trainees.

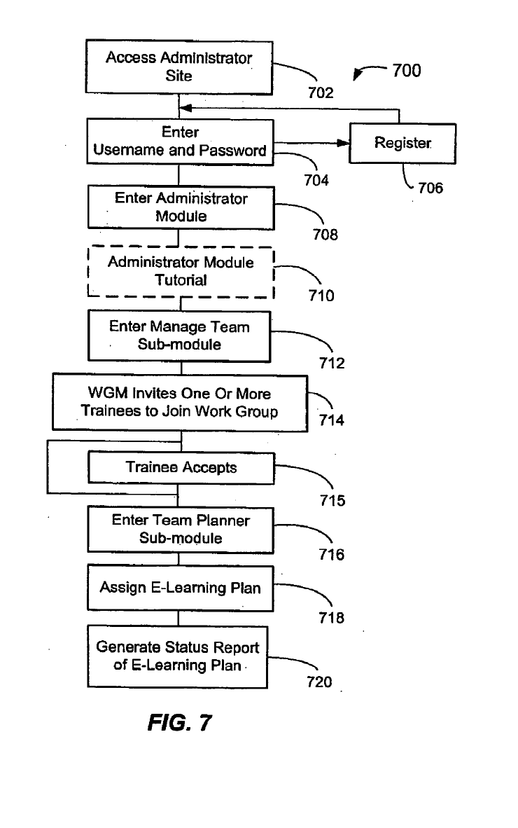

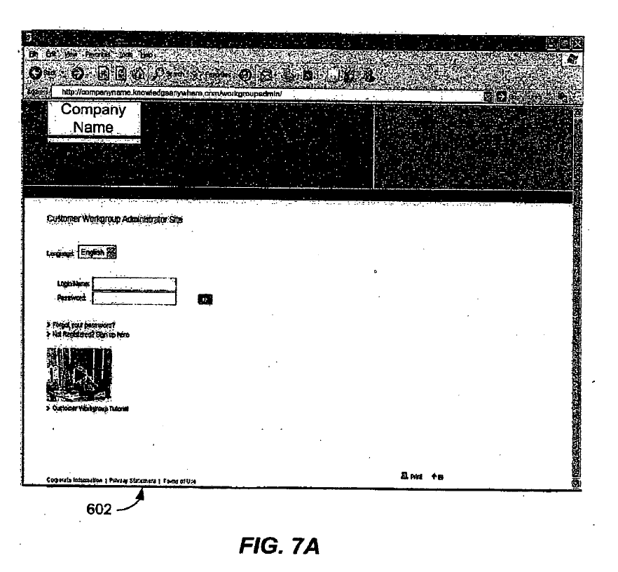

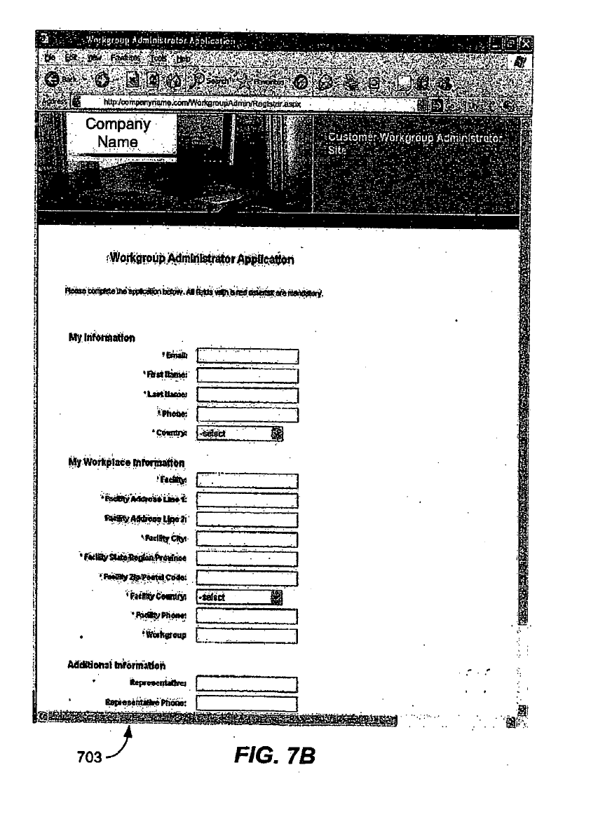

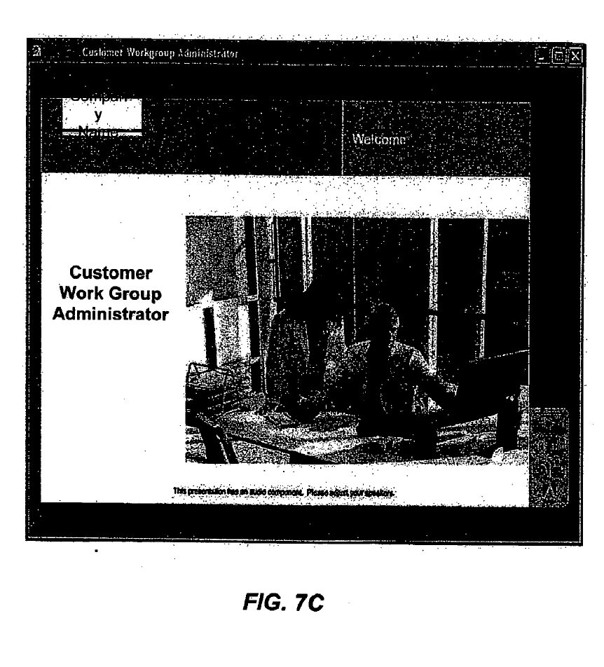

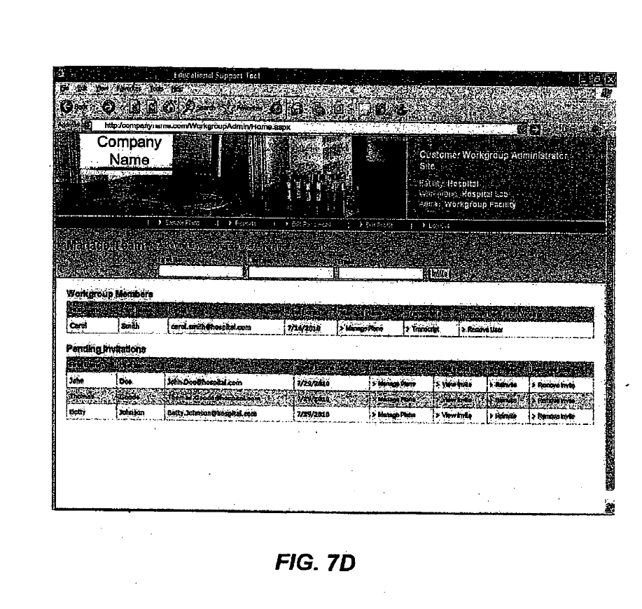

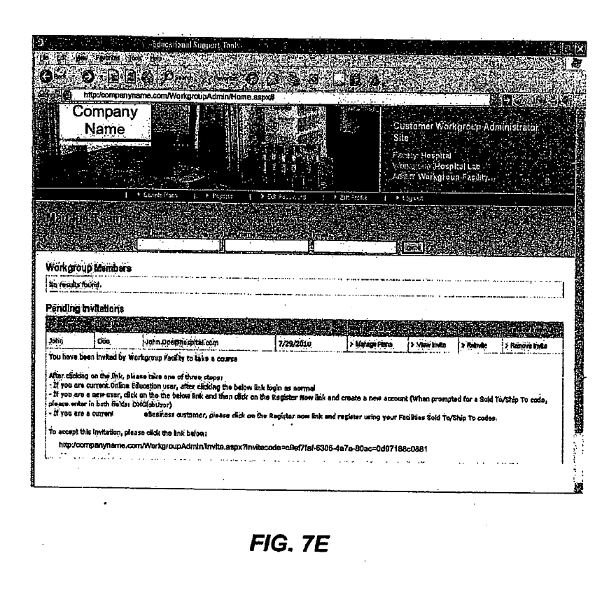

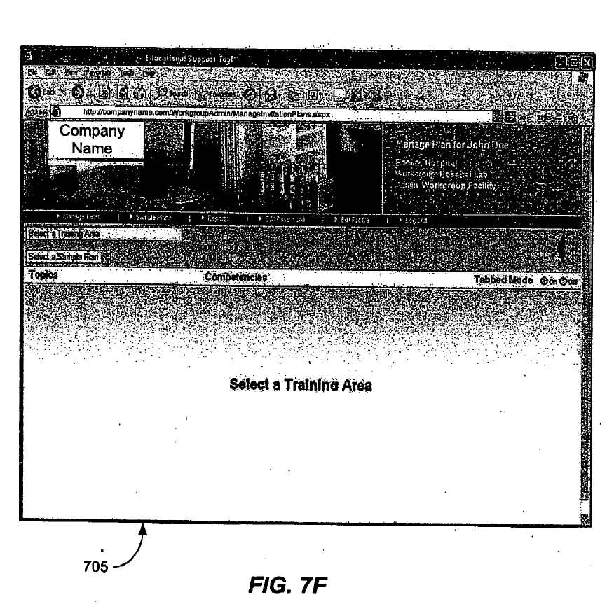

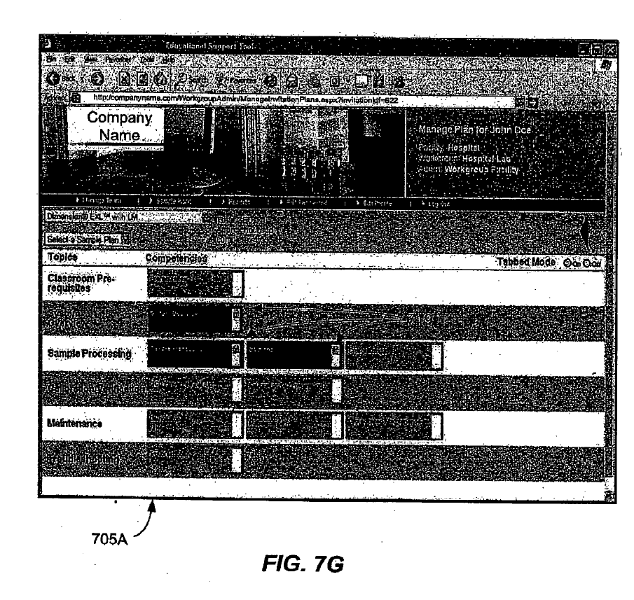

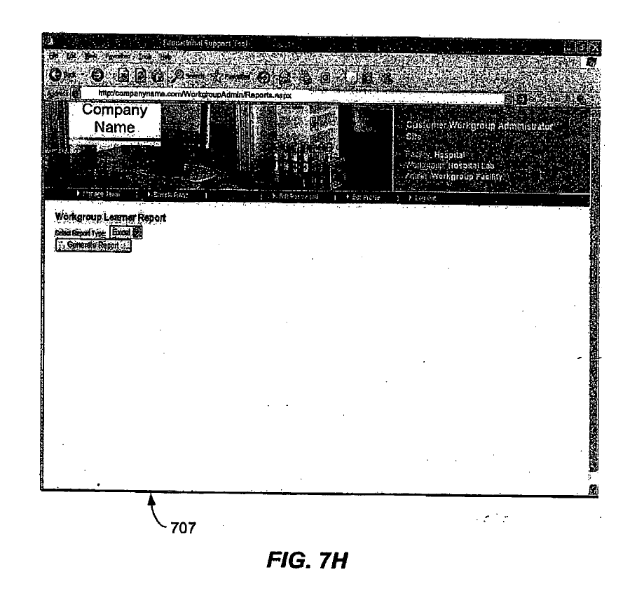

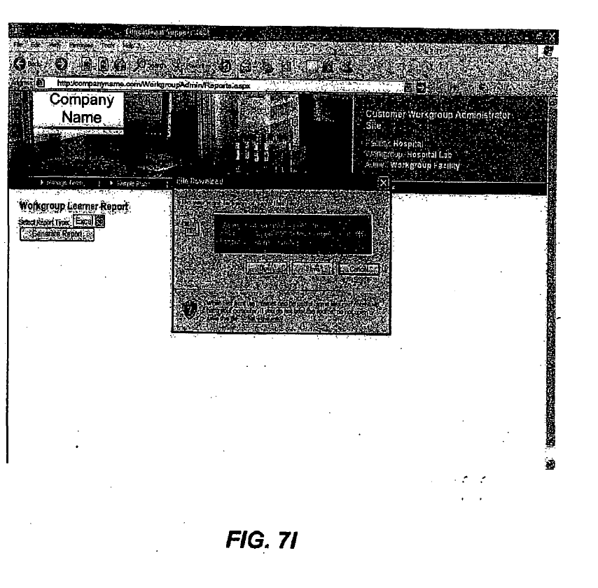

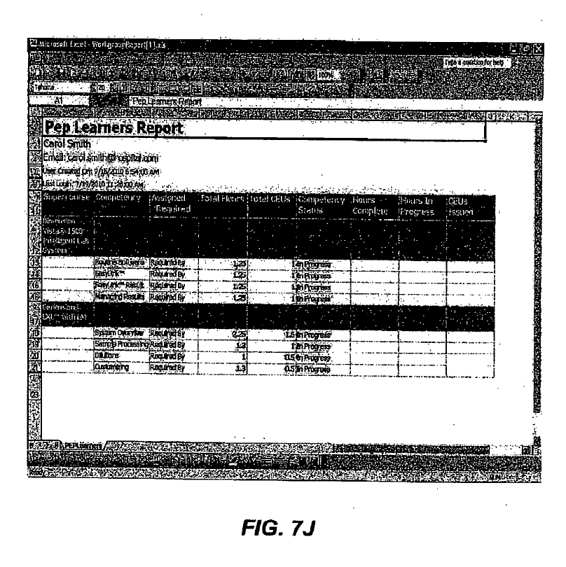

In more detail, the administrator may access the administrator module 204 by typing in the web address (e.g., www.companyname.com/workgroupadmin/). This will access the administrator module web page 602 in block 702. Once at the administrator module web page 602, the WGA may sign into the administrator module 204 in block 704 by providing a username and password. A screen shot of the administrator module web page 602 is shown in FIG. 7A. If the administrator hasn't yet registered, they may do so to obtain access to the administrator module 204 in block 706. A screen shot of the registration web page 703 is shown in FIG. 7A. If the password has been forgotten, a link may be accessed to send the password to the administrator's registered e-mail address or otherwise allow the password to be reset.

Once access is granted to the administrator module 204 in block 708, the first displayed screen may be a administrator module tutorial screen of a tutorial sub-module 604 (see FIG. 7C). The optional tutorial sub-module 604 may provide a series of slides, a video, or an animated tutorial of various features of the administrator module 204 to the newly logged-in WGA in block 710.

Next, a manage team sub-module 606 may be engaged in block 712 by the WGA. This manage team sub-module 606 may be actively engaged via a selection option by the WGM, or may be automatically launched upon completion of the optional tutorial. The manage team sub-module 606 may function to allow the WGA to manage his/her team or work group by allowing the WGA to assign and/or monitor and track training status of one or more trainees belonging to his/her functional team (e.g., work group). A screen shot of a screen display of the manage team sub-module 606 is shown in FIG. 7D. As the WGA first enters the manage team sub-module 606, none of the “Work Group Members” or “Pending Invitations” sections may be populated. To add trainees to the work group, the WGA may add the trainee's name and e-mail address to the “add a user” section and click on the radio box labeled “invite.” This sends a system-generated invite to join the work group as a work group member from the invite sub-module 607 in block 714. The invite may be in the form of an e-mail invite. An example of the invite is shown in FIG. 7E. The system-generated e-mails may be generated using MICROSOFT ASP.net, MICROFOFT® EXCHANGE SERVER, and SMTP protocol.

The invite may be accepted in block 715 by the invited trainee by accessing the e-training module from an http// link embedded in the e-mail. The trainee may already be registered to access the e-training system 200 or may need to register as shown in FIG. 5B. A password and username may be sent in the e-mail invite. Within the e-training system 200, when the invite is accepted by logging in and gaining entry into the training module 202, the “Work Group Members” section of the displayed screen of the manage team sub-module 606 may be populated. As soon as the e-mail is sent, the “Pending Invitations” section is populated. All non-accepted invitees remain listed in the “Pending Invitations” section until they accept or are removed. All the data shown may be provided to a database program that may be operating on the database server 306, such as MICROSOFT SQL Server available from Microsoft Corporation of Redmond, WA. Other database programs that may operate on a computer or server may be used. All of the video and media for enabling display of the graphics of the screen shots, videos, as well as the graphic content of the numerous e-training courses may be stored on the Video/Media Server 308. However, it should be understood that the server system 302 may include only a single server (computer) if the content of the e-training system 200 is small enough.

Once one or more work group members have been added to the work group or added as invitees, the WGA may then enter the team planner sub-module 608 in block 716 in order to plan (e.g., assign) and/or track one or more trainee's e-learning plans. The line bypassing the trainee accepts block 715 indicates that the planning may take place even before acceptance by the trainee invitee. A screen shot of an unpopulated training planner screen 705 of the team planner sub-module 608 for an individual trainee is shown in FIG. 7F. The WGA may proceed to select a training area from a drop-down listing of available training areas (e.g., Instrument Specific, Modular, General Laboratory, Clinical Applications, etc.). Optionally, the WGA may select from a group of sample plans, which may be plans already pre-populated with e-training courses. In some embodiments, the pre-populated plans may be based upon the job title or role of the trainee (e.g., Generalist 1 Trainee Plan, Specialist 1 Trainee Plan, etc.). Thus, e-learning plans for each trainee may be readily assigned and with uniformity. In the case where the trainee may have already selected certain e-training courses, those may also appear on the training planner screen. Mandatory e-training courses assigned by the WGA will be shown as locked and, if previously selected by the trainee, will be overwritten as being mandatory.

FIG. 7G illustrates a screen shot of a display screen 705A of a populated team planner sub-module 608. A specific instrument or piece of equipment may be selected from the “select training area” drop-down menu of FIG. 7F. This action extracts all the available e-training courses that are directed at the selected specific instrument or piece of equipment. Again, the e-training courses may be arranged in the same fashion as will be seen by the trainee in the trainee module 202. The WGM then proceeds to assign an e-learning plan in block 718. In the depicted example, three e-training courses have been selected and assigned by the WGA. Selection by the WGA causes a lock indicia to appear in the checkbox 719. This cannot be changed by the trainee and it indicates the e-training course is mandatory.

An adder function may add and report on the screen 705A, a number of certified education units (CEUs) available that are based upon the e-training courses that have been selected. An approximation of the number of hours to complete the training may also appear. If the WGA has already assigned certain e-training courses to the trainee, then when the trainee enters the training module 202 as discussed above, those e-training courses will appear on the trainee planner sub-module 412 as a baseline e-learning plan for the trainee. The trainee may then select from other competencies in order to enhance their understanding of the instrument or piece of equipment beyond their job title or role, for example. Optionally, the trainee may select training on other instruments or pieces of equipment or e-learning from other training categories.

As in the training module 202, the administrator module 204 may include the ability to generate various outputs (e.g., reports) in 720. By selecting the reports function, the WGM may be taken to an unpopulated work group learner report screen 707 of the output generator sub-module 610 as shown in FIG. 7H. Then by selecting the report type (e.g., MICROSOFT® EXCEL®, MICROSOFT® WORD®, or other type) and selecting the “Generate Report” radio button as shown in FIG. 7I, the screen 707A may be populated as shown in FIG. 7J. The report may be opened and printed and/or saved in the selected format. The data in the generated report is extracted from the MICROSOFT® SQL Server™ database resident on the database server 306.

### Content Manager Module

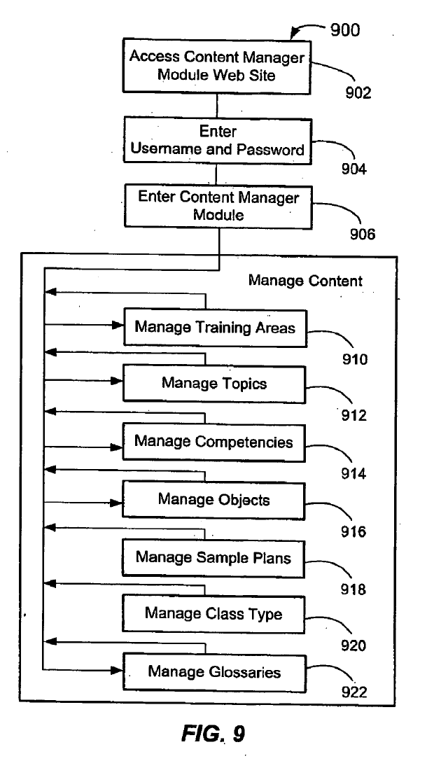

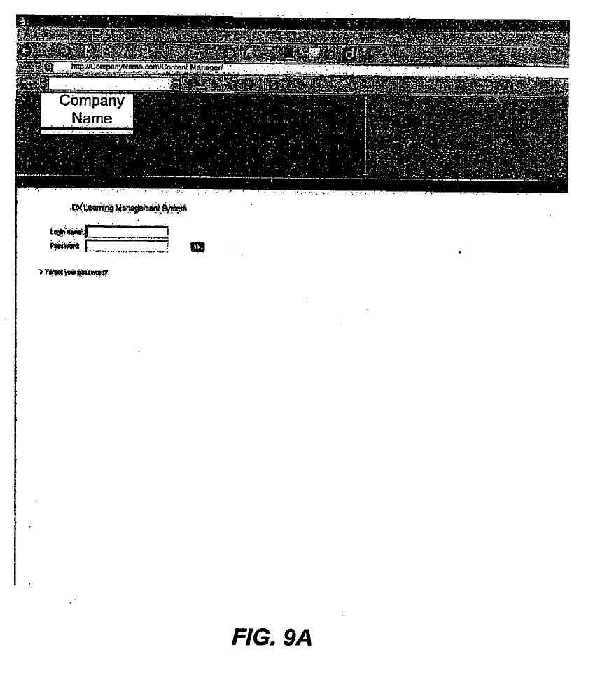

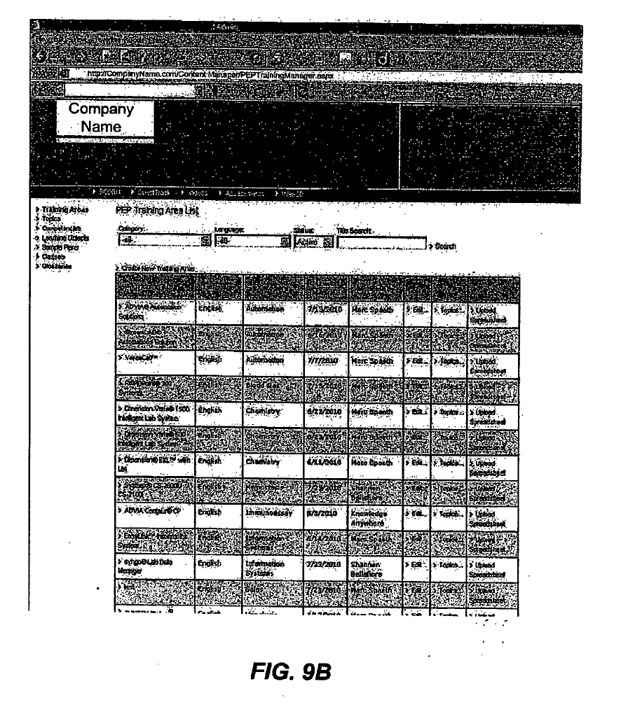

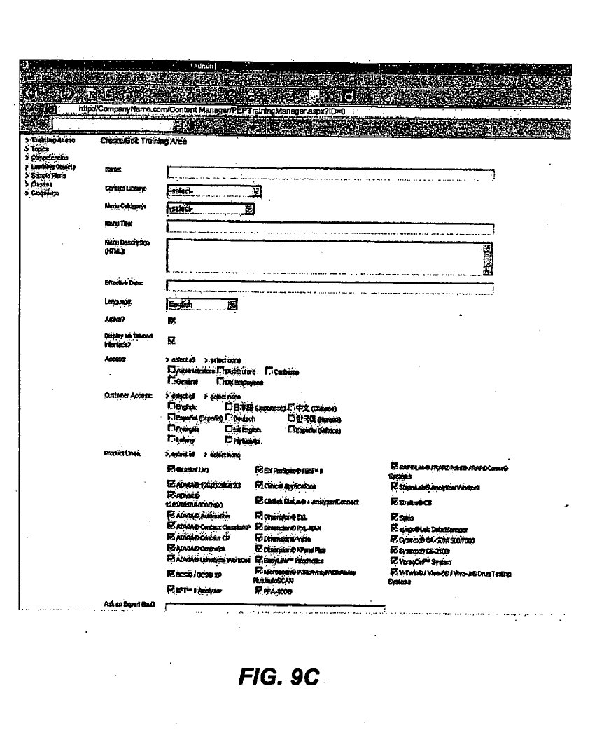

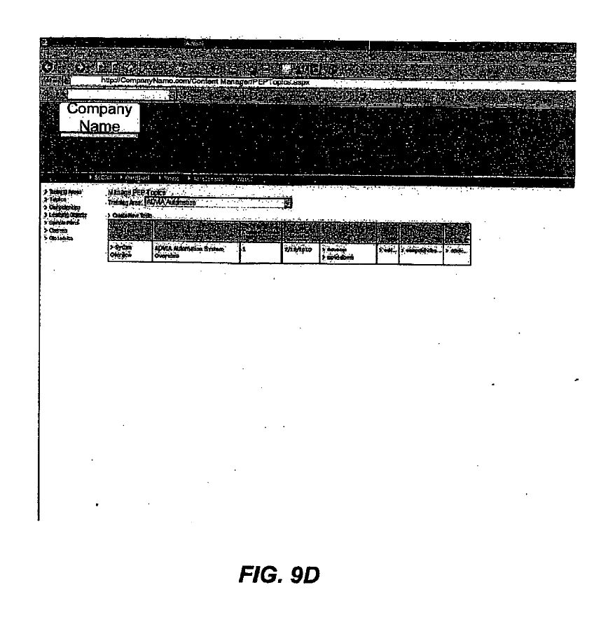

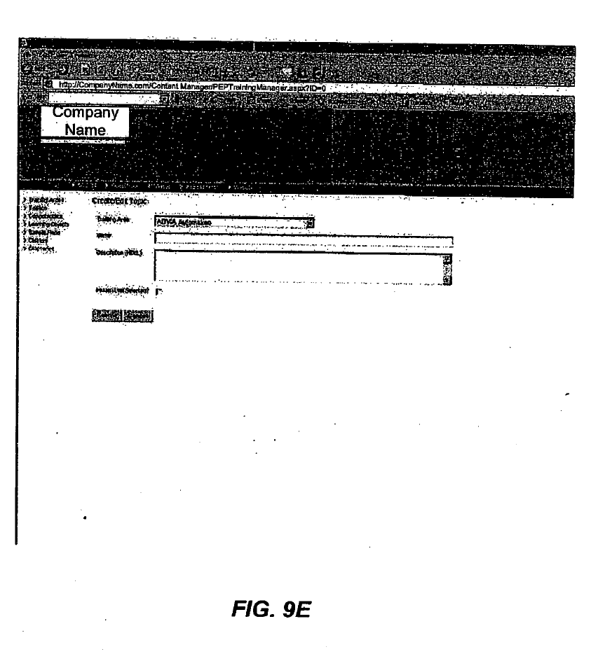

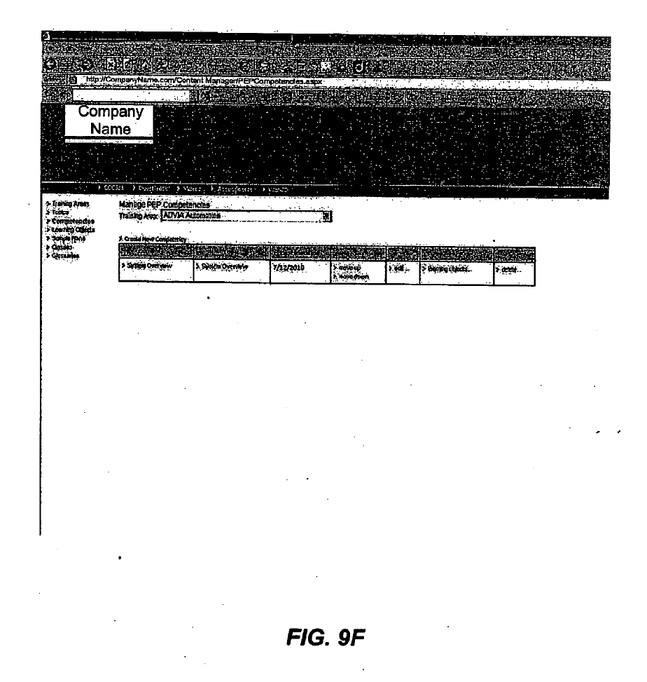

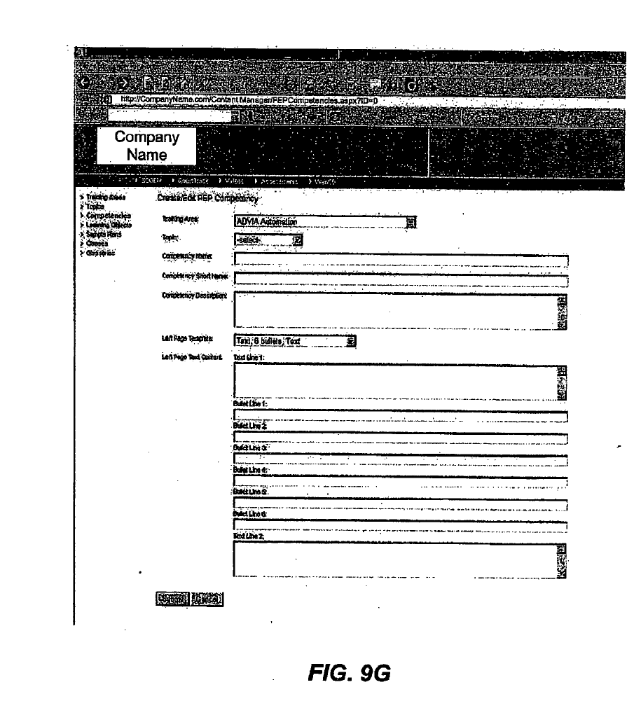

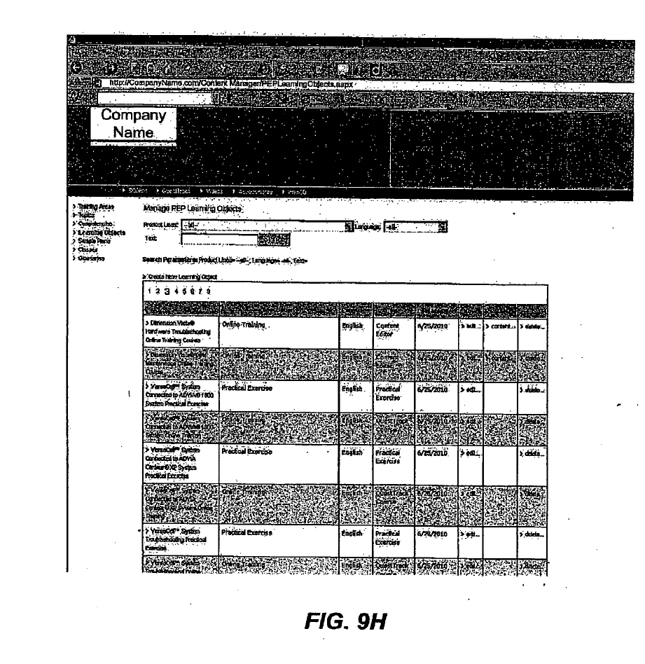

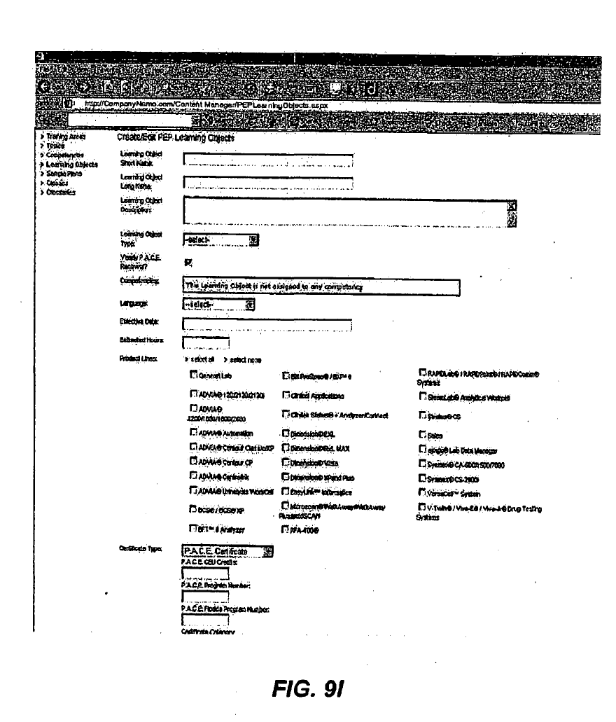

The content manager module 206 and method for operating the content manager module 900 will now be explained in detail with reference to FIGS. 2-3 and FIGS. 8-9C herein. The content manager module 206 functions to allow service personnel 214, who are typically employees or agents of the manufacturer of the instrument or piece of equipment, to access, create, update and/or delete the content of the e-training module 202 and administrator module 204. As in the other modules 202, 204, the service personnel 214 may obtain access to the content manager module 206 via a content manager module web page portal 802. A screen shot of a suitable web page is shown in FIG. 9A. By entering a username and password in block 904, the service personnel 214 may be granted access to the content manager module 206 in block 906.

Once granted access to the Content Manager Module 206, the service personnel 214 may add, edit, or delete various content areas of the e-training system 200 in a manage content sub-module 804. For example, the service personnel 214 may add, edit, or delete from the content in one or more of a manage training areas sub-module 806, manage topics sub-module 808, manage competencies sub-module 810, manage objects sub-module 812, manage sample plans sub-module 814, manage classes sub-module 816, and manage glossaries sub-module 818.

The manage training areas sub-module 806, an example of a screen shot of which is shown in FIG. 9B, includes the ability to edit any listing from all available training areas that appear in the content library of the e-training module 202. The service personnel 214 may create a new, or edit an existing training area via selecting the “Create New Training Area” or “>Edit” links. Selecting the create or edit links takes the service personnel 214 to the Create/Edit Training Area screen as shown in FIG. 9C. At that screen, the training area may be assigned or reassigned to a particular content library (e.g., 410 of FIG. 5E). Other features such as access, language, and products to which the training area relates may be selected. All product areas are selected for the example shown. However, the training area related only to a specific instrument or piece of equipment on that product may be designated. A spreadsheet of the content for any area may be uploaded and displayed to the trainee, such as in FIG. 5F.

Once the training areas have been established and populated, the topics may be added for each training area in the manage topics sub-module 808. The manage topics sub-module 808 functions to allow service personnel 214 to provide the listing of topics (see topics 515 in FIG. 5G) for each training area as shown in FIG. 9D. This includes adding/editing the text, or adding/editing a description from the create/edit topics screen shown in FIG. 9E. The order of the topics may be changed in the Manage PEP Topics sub-module.

Once the topics are populated for a training area, the service personnel 214 may use the manage competencies sub-module 810 to add, edit, or delete various competencies (e.g., 513 of FIG. 5G) for each topic. The relative position of the competency may be changed as well. A screen shot of a manage competencies screen of the sub-module 810 is shown in FIG. 9F. The create/edit competency screen is shown in FIG. 9G. Within this screen, the service personnel 214 may add/edit text, or add/edit a description.

Once the competencies are populated for a topic, the service personnel 214 may use the manage objects sub-module 812 of FIG. 9H to add, edit, or delete various learning objects for each competency. A learning object is any educational activity or educational sub-component, with clear objectives and possible assessment that provides knowledge, instruction, education, or information to a trainee. Examples include a video knowledge portion, a slide show knowledge portion, a practical exercise portion, instructional materials, and a computer-implemented written test. A screen shot of the manage learning objects screen of the manage objects sub-module 812 is shown in FIG. 9H. The create/edit earning objects screen is shown in FIG. 9I. Within this screen, the service personnel 214 may add/edit the text, description, type, language, identify whether course is certified, link to specific instrument or piece of equipment.

Additional modules (e.g., 814, 816, 818) may be employed as needed to add the content of the sample plans, classroom type, and glossary. Any number of sample plans may be added and may be accessible from the planning sub-module of the administrator module 204. Glossaries may be accessible from one or more learning areas and various terms may be linked to the glossary definitions. All of the e-training content may be stored on one or more computers of the server system 302 at one or more file locations accessible by the database software. The methods of the invention may be provided in the form of executable software. For example, the code may be a non-transitory computer-readable medium adapted to operate on one or more computers. The computer-readable medium may be stored on a suitable storage media such as on one or more hard disc drives, one or more optical discs (e.g. CDs), one or more magnetic discs, etc. Additionally, the suitable storage media may include RAM or ROM.

### Software Aspects

The web-based training method and system of the invention allows trainees and WGAs to assign e-learning plans at multiple competency levels and/or may allow track progress thereof. The method and system may be carried out on a server system 302 running Microsoft SQL Server 2005 or above, and Internet Server: IIS 6.0 or above.

All applications may be written in ASP.NET 3.5/C#, and may share a SQL Server database. Dynamic content of the various modules may be delivered using asynchronous JavaScript (AJAX) and flash. Reporting may be generated using a remote call to SQL Server Reporting Services (SSRS) 2008. Reports may be delivered from the output generator sub-modules 418, 610 using SOAP and the SSRS web service. Reports may be delivered in PDF, Excel, HTML and Word formats, for example. All applications adapted to be accessed by the trainees and/or WGA may be provided in French, Italian, German, Spanish, Portuguese, Chinese and Korean, for example. Emails generated by the invite sub-module 607 may be generated using ASP.NET/C#. Such e-mails may be sent using a SMTP mail server.

Testing Routine—The system testing in test routine sub-module 404 may be carried out using CyScape BrowserHawk.

Tutorials—The test routine sub-modules 404, 604 may provide a short video introduction/tutorial. Other web pages may include tutorials as well. Each tutorial (e.g., video) may automatically play a first time a trainee/WGM visits a page, and can subsequently be viewed using a link. The videos may be displayed using a Flash played, and all videos may be preloaded in small chunks when the trainee/WGM first logs in.

Content Library—The content may be stored at various file locations on the web server system 302, and accessed through an ASP.NET/C# menu page. The menu page is maintained using the content manager module 206.

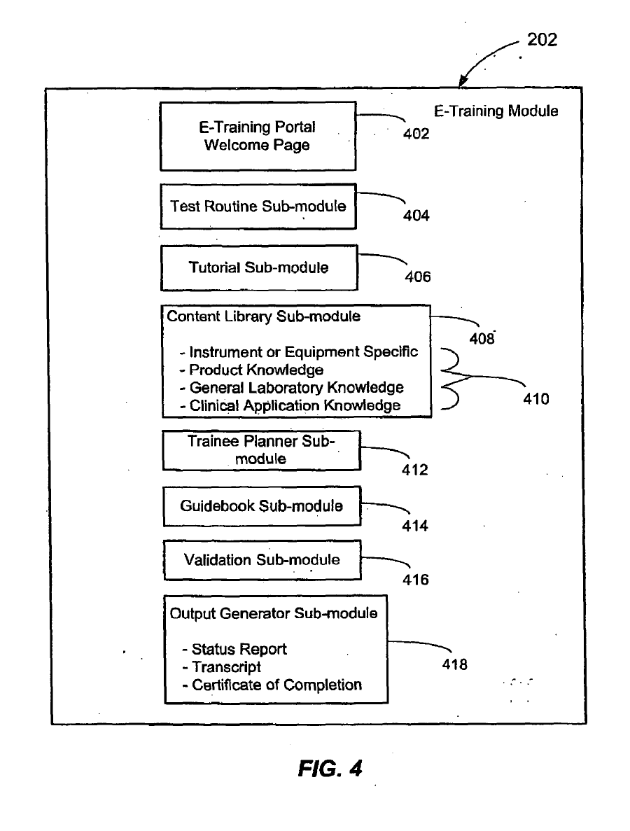

Trainee Planner—The trainee planner sub-module 406, as described above with reference to FIG. 4 and FIG. 5G, allows trainees to access and update their e-learning plans. Each box represents a competency. This page (screen) is written using extensive JavaScript and clicking the check boxes 517 may cause competencies to be added/removed from the trainee's e-learning plan. The adding/removing of competencies is handled via asynchronous JavaScript calls to the database which updates the User Competencies table in the SQL Server database.

The select a sample plan dropdown may allow the trainee to select a predefined sample e-learning plan. Sample e-learning plans may be defined through the content manager module 206 or by a WGA. Competencies assigned by a WGA may be locked and may not be removed by a trainee. The planner page may have a tabbed view and a matrix view.

Guidebook—The guidebook submodule 414 may be provided as a flash animation that may consume XML delivered by a C# page. The guidebook may be dynamically generated by the guidebook sub-module 414 based on the trainee's e-learning plan, and may contain one or more pages for each competency. There may also be a summary cover page and/or a slide in a table of contents. Several of the links in the flash may make external JavaScript calls to launch content. After content has been launched, the guidebook may be silently refreshed (no page load).

The guidebook flash may allow a trainee to flip between pages using a standard mouse (like a book), use a back/next button on the page, and/or navigate using a slide in a table of content control. One page of each competency may deliver several types of content, including videos, slides, or other animations. Listed below is an exemplary XML that may be used by the guidebook.

Validation Sub-module—The validation of completion of the e-training activities varies by type of training object. For a simple e-training object (i.e. viewing a .pdf or .doc), simply opening the file may marks completion thereof. For an e-training course, the trainee generally must complete a test, and the results are sent back to the guidebook sub-moldule using the Shareable Content Object Reference Module (SCORM) standard. For a practical exercise, the trainee must validate that they have completed all the steps in a practical exercise, which may listed on a downloaded document. A checkbox is used as an electronic confirmation which then populate the database and updates the guidebook.

Administrator Module—A WGM may gain access to the administrator module 204 by self-registering as discussed above, or by being invited by a service personnel 214 wherein approval may be sent via email. All content such as workgroups, invitations, competencies, trainee information, WGA information, etc. may be contained in the database. As discussed above, the administrator module 204 may be used by WGAs to manage a team of trainees (e.g., 210A-210D). WGAs (e.g. 212A) may invite trainees to join their workgroup via email. The email may be automatically generated and sent to the trainee with a link. When the link is clicked, a cookie may be dropped on the learner's computer and the login procedure may check for this cookie and may add the trainee to a workgroup. Once a trainee has been added, the WGA (e.g. 212A) may assign e-learning plans and view a trainee's transcript. As discussed above, the WGA may also assign e-learning plans before an invitation has been accepted by the trainee.

Output Generator—As described above, the output generator sub-module 418 (FIG. 4) may generate a transcript or other output. The transcript may be an HTML report generated using an ASP.NET User Control with a GridView. The report may list completion of individual e-training courses and may allow trainees to print a certificate of completion when an e-training course has been completed. Trainees may also launch learning objects from this screen (See FIG. 5I). The certificates of completion may be delivered using SSRS, for example.

Content Manager Module—All content (training topics, competencies, objects, sample plans, classes, glossaries, etc.) may be stored in the database in database tables, for example, and on the file system of the server system 302. The original and updated content may be uploaded and entered by service personnel through the ASP.NET/C# Content Manager Module 206.

Thus, it should be apparent that in one aspect, the present invention provides a single-source educational platform to allow one or more trainees to obtain, validate, and track their e-learning plan for a particular instrument or piece of equipment. In another aspect, the single source educational platform may allow a WGM to invite one or more trainees to a work group and assign and/or track e-training for one or more trainees on a particular instrument or piece of equipment. A content manager module allows service personnel to seamlessly access and update content of the e-training module and administrator module.

While the invention is susceptible to various modifications and alternative forms, specific system and apparatus embodiments and methods thereof have been shown by way of example in the drawings and are described in detail herein. It should be understood, however, that it is not intended to limit the invention to the particular systems, apparatus, or methods disclosed but, to the contrary, the intention is to cover all modifications, equivalents, and alternatives falling within the spirit and scope of the invention.

What is claimed is:

1. A web-based, training method for an instrument or piece of equipment, comprising:
accessing a web-based portal operable on a server system;
accessing an e-training module via the web-based portal, the e-training module including a collection of one or more e-training courses directed at attaining a competency on the instrument or piece of equipment;
selecting one or more e-training courses from the collection of one or more e-training courses to generate an e-learning plan;
engaging in learning with at least one of the one or more selected e-training courses, the learning involving completion of a knowledge portion and validation of completion of a practical portion; and
generating at least one selected from the group of:
a status report of the e-learning plan,
a certificate of completion for at least one e-training course from the e-learning plan, and
a transcript of at least some e-training courses from the e-learning plan.

2. The web-based, e-training method of claim 1, further comprising:
performing e-validation of an unguided portion and guided portion of the practical portion.

3. The web-based, e-training method of claim 1, further comprising:
selecting a content library having a listing of one or more e-training areas; and
selecting an e-training area from the listing of one or more e-training areas.

4. The web-based, e-training method of claim 1, further comprising selecting an e-training course from one or more competency topics selected from a group of competency topics consisting of:
routine operation of the instrument or piece of equipment (“Routine Operations”);
calibration of the instrument or piece of equipment (“Calibration”);
maintenance of the instrument or piece of equipment (“Maintenance”);
software updates to an instrument or piece of equipment (“Updates”); and
quality control processing of the instrument or piece of equipment (“Quality Control”).

5. The web-based, e-training method of claim 1, wherein a status of a knowledge portion, a practical portion, and a validation portion is displayed on a guidebook.

6. The web-based, e-training method of claim 1, wherein one or more e-learning topics from the collection of one or more available e-learning courses is selected by an administrator for a trainee.

7. The web-based, e-training method of claim 1, wherein one or more e-learning topics from the collection of one or more available e-learning courses is selected by an administrator for a trainee, and one or more e-learning topics from the collection of one or more available e-learning courses is selected by the trainee.

8. The web-based, e-training method of claim 1, further comprising requesting as an administrator the generation of a report of a status of the e-learning plan.

9. The web-based, e-training method of claim 1, further comprising receiving a system-generated invite by the one or more trainees to join a work group.

10. The web-based, e-training method of claim 9, wherein the system-generated invite to the one or more trainees to join a work group is from a work group administrator in a form of an e-mail.

11. The web-based, e-training method of claim 1, wherein at least some of the e-training courses are accredited, and generating a transcript of the accredited e-training courses which have been completed.

12. The web-based, e-training method of claim 1, further comprising requesting the generation of a status report of a selected e-training course of the e-learning plan.

13. The web-based, e-training method of claim 1, further comprising viewing a guidebook to determine a status of one or more e-training courses.

14. A web-based, e-training method for an instrument or piece of equipment, comprising:
providing a web-based portal operable on a server system accessible by a work group administrator;
providing an e-training module on the server system and accessible by one or more trainees via the web-based portal, the e-training module being accessible by the one or more trainees to take one or more available e-training courses directed at attaining a level of competency on the instrument or piece of equipment;
providing a system-generated invite to the one or more trainees to join a work group; and
receiving a selection from the work group administrator of one or more e-training courses from the one or more available e-training courses to assign an e-learning plan to the one or more trainees.

15. The web-based, e-training method of claim 14, further comprising generating a status report of the e-learning plan of the one or more trainees.

16. The web-based, e-training method of claim 14, further comprising receiving from a trainee a selection of one or more e-training courses directed at attaining a plurality of competencies for the instrument or piece of equipment.

17. The web-based, e-training method of claim 14, further comprising receiving a selection of an e-learning plan from a group of available and pre-populated sample e-learning plans directed at achieving different competencies for the instrument or piece of equipment.

18. The web-based, e-training method of claim 14, further comprising receiving a selection of one or more e-training courses from one or more competency topics, which are selected from a group of competency topics consisting of:
routine operation of the instrument or piece of equipment (“Routine Operations”);
calibration of the instrument or piece of equipment (“Calibration”);
maintenance of the instrument or piece of equipment (“Maintenance”);
software updates to an instrument or piece of equipment (“Updates”); and
quality control processing of the instrument or piece of equipment (“Quality Control”).

19. The web-based, e-training method of claim 14, wherein the system-generated invite to the one or more trainees to join a work group comprises sending an e-mail to the one or more trainees.

20. The web-based, e-training method of claim 19, further comprising populating a work group listing accessible by the work group administrator based upon acceptance of the invite by the one or more trainees.

21. A web-based, training system adapted to provide training on an instrument or piece of equipment, comprising:
a server system operable to provide a web-based portal accessible by one or more trainees; and
an e-training module operable on the server system accessible by one or more trainees via the web-based portal, the e-training module including
a content library sub-module containing a collection of one or more e-training courses directed at the instrument or piece of equipment,
a trainee planner sub-module adapted to allow a trainee to select one or more of the e-training courses and generate an e-learning plan,
a validation sub-module adapted to validate completion of a knowledge portion and validation of completion of a practical portion, and
an output generator adapted to generate at least one output selected from the group of:
a status report of the e-learning plan indicating a status of each selected e-training course of the e-learning plan,
a transcript of all completed e-training courses from the e-learning plan, and
a certificate of completion for at least one e-training course from the e-learning plan.

22. The web-based, training system of claim 21, further comprising:
a work group administrator planner sub-module adapted to allow a work group administrator to select one or more e-learning courses and generate an e-learning plan for a trainee.

23-24. (canceled)

25. A non-transitory computer-readable medium adapted to operate on one or more computers, the computer-readable medium comprising:
storage media containing:
an e-training module adapted to be accessible by one or more trainees, the e-training module including
a content library sub-module containing a collection of one or more e-training courses directed at the operation, calibration, maintenance, control testing, or troubleshooting of an instrument or piece of equipment;
a trainee planner sub-module adapted to allow a trainee to select one or more of the e-training courses and generate an e-learning plan;
a validation sub-module adapted to validate completion of a knowledge portion and validate completion of a practical portion; and
an output generator sub-module adapted to generate at least one output selected from the group of:
a status report of the e-learning plan indicating a status of each selected e-training course of the e-learning plan,
a transcript of all completed e-training courses from the e-learning plan, and
a certificate of completion of one or more e-training courses from the e-learning plan.

26-29. (canceled)
